(19) United States
(12) Patent Application Publication
(10) Pub. No.: US 2011/0246304 A1
(43) Pub. Date: Oct. 6, 2011

(54) METHOD AND SYSTEM FOR PROVIDING TARGETED ADVERTISEMENTS BASED ON POSITIONAL TRACKING OF MOBILE DEVICES AND FINANCIAL DATA

(76) Inventors: Terry Hicks, San Mateo, CA (US); Sridhar Jagannathan, Los Altos, CA (US)

(21) Appl. No.: 12/750,961

(22) Filed: Mar. 31, 2010

(51) Int. Cl. G06Q 30/00

(52) U.S. Cl. 705/14.58

(57) ABSTRACT

A method and system for providing targeted advertisements based on positional tracking of mobile devices and financial data whereby data associated with one or more participating businesses is obtained including, but not limited to, the business name and the business location. A mobile device associated with a consumer is associated with financial data associated with the consumer and the position of the mobile device associated with the consumer is tracked. A probability that the consumer will respond to an offer or advertisement for a particular participating business, and/or specific products and/or services associated with a particular participating business, is then determined for the consumer based, at least in part on the financial data associated with the consumer. The consumer's estimated arrival time at a defined point in the vicinity of the particular participating business is then calculated and the participating business is provided the opportunity to send the consumer one or more offers and/or information regarding the participating business in relative “real-time”.

### BACKGROUND

Advertising and marketing represents a significant on-going expense for most businesses, i.e., sellers and/or providers of consumer goods and services. Consequently, both business owners/operators and providers of marketing and advertising tools are constantly looking for new ways to provide advertising to potential customers, i.e., consumers.

In order to most efficiently use their marketing and/or advertising resources, businesses would prefer to access consumers who are in their immediate area at a given time and/or are known to be interested in their particular products and services.

In addition, most consumers would prefer to receive advertising that is relevant to their location and that is relevant to the consumer, i.e., that is of use to the consumer and/or is directed to products and/or services the consumer already desires and/or uses.

Despite the desire of businesses, as well as consumers, to create a better system for reaching nearby, relevant, and likely interested consumers in relative real time, there currently is often no information, or limited information, available to the business owner/operator regarding both a location of a given consumer and information that can enable the businesses to accurately identify a nearby consumer as an interested, desirable, and/or probable, customer.

As a result of the situation discussed above, business owners/operators are currently often denied the ability to identify and target particularly likely and desirable consumers in their vicinity, providers of marketing and advertising tools are denied the opportunity to profit by providing the business owners/operators access to particularly likely and desirable consumers in the vicinity of the business, and consumers are denied knowledge of nearby businesses and savings and efficiency that might otherwise be available to them. Consequently, the current situation represents a disservice to business owners/operators, providers of marketing and advertising tools, as well as consumers/potential customers.

### SUMMARY

In accordance with one embodiment, a method and system for providing targeted advertisements based on positional tracking of mobile devices and financial data includes a process for providing targeted advertisements based on positional tracking of mobile devices and financial data whereby, in one embodiment, data associated with one or more participating businesses is obtained including, but not limited to, data indicating one or more of: the business name; the business location; and/or products/services provided by the business. In one embodiment, a mobile device associated with a consumer is linked, or otherwise associated with, financial data associated with the consumer obtained, in one embodiment, from a financial management system used by the consumer. In one embodiment, the position of the mobile device associated with the consumer is tracked and an estimated direction/path and speed of the consumer is thereby determined. In one embodiment, a probability that the consumer will respond to an offer or advertisement for a particular participating business, and/or an offer or advertisement associated with specific products and/or services associated with a particular participating business, is then determined for the consumer based, at least in part on, but not limited to, one or more of the following probability of use parameters: how close the estimated direction/path of a consumer brings the consumer to the particular participating business; generalized consumer usage data; the time of day, day of the week, or date; personalized consumer usage data such as whether the consumer has historically utilized the particular participating business, or businesses offering products and/or services similar to the products and/or services offered by the particular participating business, and/or whether the consumer has historically utilized the particular participating business, or businesses offering products and/or services similar to the products and/or services offered by the particular participating business, at the determined time of day, day of the week, or date; or any other probability of use parameter, or combination of probability of use parameters, defined by the process for providing targeted advertisements based on positional tracking of mobile devices and financial data and/or one or more participating businesses. In one embodiment, the consumer's estimated arrival time at the projected closest point to the particular participating business is then calculated, and/or updated, using the tracked position of the mobile device associated with the consumer and/or the estimated direction/path and speed of the consumer. In one embodiment, the participating business is then provided the opportunity to send the consumer one or more offers and/or information regarding the participating business that can include, but are not limited to, an advertisement, a coupon, and/or any other marketing device, and/or electronic media based advertisement and/or marketing device. In one embodiment, the one or more offers and/or information regarding the participating business are provided to the consumer through the mobile device associated with the consumer. In one embodiment, the participating business is provided information regarding the calculated best time to send the consumer the one or more offers and/or information regarding the participating business to maximize the probability that the one or more offers and/or information will result in the consumer utilizing the participating business, i.e., to maximize the consumer's probability of use. In one embodiment, the one or more offers and/or information regarding the participating business are monitored to obtain usage/redemption feedback data that is then used to refine future recommendations and track the effectiveness of the various offers and/or information disseminated.

Using the method and system for providing targeted advertisements based on positional tracking of mobile devices and financial data discussed herein, actual financial data associated with consumers and actual potential customer positions, and/or predicted potential customer paths and movement, are used to provide a business owner the information to more accurately identify potential customers and to identify potential customers who are currently in the vicinity of the business, and/or are predicted to be in the vicinity of the business at a given time. Then using the method and system for providing targeted advertisements based on positional tracking of mobile devices and financial data discussed herein, the business owner/operator is provided the opportunity to specifically target those potential customers with advertisements and/or offers and to provide the potential customers advertisements and/or offers at the most advantageous time, e.g., when the potential customers are nearby, yet have time to divert from their current path to make a stop at the given business. Consequently, using the method and system for providing targeted advertisements based on positional tracking of mobile devices and financial data, as discussed herein, businesses are provided the information and mechanism necessary to most effectively and efficiently target consumers and consumers are provided the ability to receive offers/advertisements that are most relevant, and potentially useful, to the consumer. Therefore, both businesses and consumers are directly benefited by use of the method and system for providing targeted advertisements based on positional tracking of mobile devices and financial data discussed herein.

### BRIEF DESCRIPTION OF THE DRAWINGS

FIG. 1 is a block diagram of an exemplary hardware architecture for implementing one embodiment including “N” mobile computing systems connected to a mobile communication network, and a provider computing system, a merchant computing system, and databases, connected by a network in accordance with one embodiment;

FIG. 2 is a block diagram of a exemplary memory system associated with the provider computing system of FIG. 1, in accordance with one embodiment; and

FIG. 3 is a flow chart depicting one embodiment of a process for providing targeted advertisements based on positional tracking of mobile devices and financial data in accordance with one embodiment.

Common reference numerals are used throughout the FIGS. and the detailed description to indicate like elements. One skilled in the art will readily recognize that the above FIGS. are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. The following description includes reference to specific embodiments for illustrative purposes. However, the illustrative discussion below is not intended to be exhaustive or to limit the invention to the precise forms disclosed. Many modifications and variations are possible in view of the teachings below. The embodiments discussed below were chosen and described in order to explain the principles of the invention, and its practical applications, to thereby enable others skilled in the art to utilize the invention and various embodiments with various modifications as may be suited to the particular use contemplated. Therefore, embodiments may be embodied in many different forms other than those shown and discussed herein and should not be construed as limited to the embodiments set forth herein, shown in the FIGS., and/or described below.

In accordance with one embodiment, a method and system for providing targeted advertisements based on positional tracking of mobile devices and financial data includes a process for providing targeted advertisements based on positional tracking of mobile devices and financial data whereby, in one embodiment, data associated with one or more participating businesses is obtained including, but not limited to, data indicating one or more of: the business name; the business location; and/or products/services provided by the business. In one embodiment a mobile device associated with a consumer is linked, or otherwise associated with, financial data associated with the consumer obtained, in one embodiment, from a financial management system used by the consumer. In one embodiment, the position of the mobile device associated with the consumer is tracked and an estimated direction/path and speed of the consumer is thereby determined. In one embodiment, a probability that the consumer will respond to an offer or advertisement for a particular participating business, and/or an offer or advertisement associated with specific products and/or services associated with a particular participating business, is then determined for the consumer based, at least in part on, but not limited to, one or more of the following probability of use parameters: how close the estimated direction/path of a consumer brings the consumer to the particular participating business; generalized consumer usage data; the time of day, day of the week, or date; personalized consumer usage data such as whether the consumer has historically utilized the particular participating business, or businesses offering products and/or services similar to the products and/or services offered by the particular participating business, and/or whether the consumer has historically utilized the particular participating business, or businesses offering products and/or services similar to the products and/or services offered by the particular participating business, at the determined time of day, day of the week, or date; or any other probability of use parameter, or combination of probability of use parameters, defined by the process for providing targeted advertisements based on positional tracking of mobile devices and financial data and/or one or more participating businesses. In one embodiment, the consumer's estimated arrival time at the closest point in the vicinity of the particular participating business is then calculated, and/or updated, using the tracked position of the mobile device associated with the consumer and/or the estimated direction/path and speed of the consumer. In one embodiment, the participating business is then provided the opportunity to send the consumer one or more offers and/or information regarding the participating business that can include, but are not limited to, an advertisement, a coupon, and/or any other marketing device, and/or electronic media based advertisement and/or marketing device. In one embodiment, the one or more offers and/or information regarding the participating business are provided to the consumer through the mobile device associated with the consumer. In one embodiment, the participating business is provided information regarding the calculated best time to send the consumer the one or more offers and/or information regarding the participating business to maximize the probability that the one or more offers and/or information will result in the consumer utilizing the participating business, i.e., to maximize the consumer's probability of use. In one embodiment, the one or more offers and/or information regarding the participating business are monitored to obtain usage/redemption feedback data that is then used to refine future recommendations and track the effectiveness of the various offers and/or information disseminated.

In accordance with one embodiment, one or more participating businesses are registered with and/or subscribe to the process for providing targeted advertisements based on positional tracking of mobile devices and financial data. In one embodiment, as part of the subscription/registration process, the one or more participating businesses provide the process for providing targeted advertisements based on positional tracking of mobile devices and financial data various business related data including, but not limited to, one or more of data indicating: the participating business name; the participating business location; products/services provided by the participating business; the participating business hours of operation; various logistical data associated with the participating business such as parking availability, seating capacity, etc.; and/or any other data associated with the participating business desired by the provider of the process for providing targeted advertisements based on positional tracking of mobile devices and financial data and/or one or more businesses.

Herein, the terms “business”, “merchant”, and “seller”, are used interchangeably and include, but are not limited to, providers of goods and services, and other advertisers, and/or any party and/or entity that interfaces with, and/or to whom information is provided by, a process for providing targeted advertisements based on positional tracking of mobile devices and financial data, and/or a person and/or entity that interfaces with, and/or to whom information is provided by, a process for providing targeted advertisements based on positional tracking of mobile devices and financial data, and/or any authorized agent of any party and/or person and/or entity that interfaces with, and/or to whom information is provided by, a process for providing targeted advertisements based on positional tracking of mobile devices and financial data.

In one embodiment, a participating business provides their business related data via one or more user interface screens displayed on one or more display devices associated with one or more merchant computing systems that are controlled by, accessible by, or otherwise associated with the participating business, a participating business owner, a participating business employee, or any agent for the participating business. In one embodiment, the one or more participating businesses provide their business related data via one or more merchant computing systems and/or a user interface device such as a keyboard, mouse, touchpad, voice command recognition system, or any other device capable of providing user input to a computing system or for translating user actions into computing system operations, whether available or known at the time of filing or as developed later.

As used herein, the term “computing system”, includes, but is not limited to: a desktop computer; a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

In one embodiment, the business related data associated with each of the participating businesses is obtained by the process for providing targeted advertisements based on positional tracking of mobile devices and financial data via any network or network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein, and/or as available or known at the time of filing, and/or as later developed.

In one embodiment, the business related data associated with each of the participating businesses is obtained by the process for predicting customer flow and arrival times using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

In one embodiment, the business related data associated with each of the participating businesses is obtained by the process for providing targeted advertisements based on positional tracking of mobile devices and financial data and the data is then stored in a participating business database.

As used herein, the term “database” includes any data storage mechanism known at the time of filing or as developed thereafter, such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, known at the time of filing, or as developed thereafter.

In one embodiment, one or more mobile devices associated with one or more consumers are linked, or otherwise associated with, financial data associated with the consumers.

Herein, the term “mobile device” includes, but is not limited to: a mobile “computing system”; a portable computer; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device and/or computing system that includes components that can execute all, or part, of any one of the processes and/or operations as described herein. In addition, as used herein, the term mobile device, can denote, but is not limited to, computing systems made up of multiple: wireless devices; cellular telephones; digital telephones; two-way pagers; PDAs; media players; or any desired combination of these devices and/or computing systems, that are coupled to perform the processes and/or operations as described herein.

In one embodiment, one or more mobile devices associated with one or more consumers are linked, or otherwise associated with, financial data associated with the consumers obtained from one or more financial management systems used by the consumers.

In one embodiment, the one or more financial management systems are any one of various financial management systems including, but not limited to, any computing system implemented, on-line or web-based, system, package, program, module, or application that gathers financial data, has the capability to analyze and categorize at least part of the financial data into various reports or displays that are provided to the user, and includes financial transaction data associated with the user.

Types of financial management systems currently available include, but are not limited to any of the following: an on-line, or web-based, or computing system implemented personal or business financial management system, package, program, module, or application; an on-line, or web-based, or computing system implemented home or business inventory system, package, program, module, or application; an on-line, or web-based, or computing system implemented personal or business asset management system, package, program, module, or application; an on-line, or web-based, or computing system implemented personal or business accounting system, package, program, module, or application; or any of the numerous on-line, or web-based, or financial management systems as discussed herein, and/or as known in the art at the time of filing, and/or as developed after the time of filing.

Specific examples of financial management systems currently available include, but are not limited to: Quicken', available from Intuit Inc. of Mountain View, Calif.; Quicken Online', available from Intuit Inc. of Mountain View, Calif.; Quickbooks™, available from Intuit Inc. of Mountain View, Calif.; Mint.com™, available from Intuit Inc. of Mountain View, Calif.; Microsoft Money', available from Microsoft, Inc. of Redmond, Wash.; or various other financial management systems discussed herein, or known to those of skill in the art at the time of filing, or as developed after the time of filing.

In one embodiment, data identifying a given mobile device associated with a given consumer, and/or data linking the given mobile device associated with a given consumer to financial data associated with the given consumer, and/or at least part of the financial data associated with the given consumer, is obtained and stored in a financial data database and/or any database as discussed herein, and/or as known/available in the art at the time of filing, and/or as developed after the time of filing.

In one embodiment, the positions of the one or more mobile devices associated with one or more consumers are tracked. In one embodiment, the one or more mobile devices associated with one or more consumers are registered with the process for providing targeted advertisements based on positional tracking of mobile devices and financial data by any method, means, mechanism or procedure for registering a computing system and/or device, as discussed herein, and/or available or known at the time of filing, and/or as developed after the time of filing. In one embodiment, the one or more mobile devices associated with one or more consumers are not specifically registered with the process for providing targeted advertisements based on positional tracking of mobile devices and financial data, but are tracked by the process for providing targeted advertisements based on positional tracking of mobile devices and financial data through one or more mobile communication networks.

In one embodiment, the consumers are provided the option to receive offers and/or information regarding the products or services associated with the participating businesses. In one embodiment, the consumer must specifically agree to receive offers and/or information regarding the product or service associated with the participating businesses, i.e., the consumer must opt-in, in order to protect the consumer's privacy and any desire the consumer may have to avoid receiving such offers/information.

In one embodiment, as part of the registration process, the consumers agree to receive offers and/or information regarding products or services associated with one or more businesses and/or providers of products or services through the financial management system via user input through a user interface device such as a keyboard, mouse, touchpad, voice command recognition system, or any other device capable of providing user input to a computing system or for translating user actions into computing system operations, whether available or known at the time of filing or as developed later.

In one embodiment, the one or more mobile devices are connected by one or more mobile communication networks such as, but not limited to: any general network, communications network, or general network/communications network system; a cellular network; a wireless network; a combination of different network types, or other wireless, wired, and/or a wireless and wired combination network; a public network; a private network; a satellite network; a cable network; or any other network capable of allowing communication between two or more computing systems, as discussed herein, and/or available or known at the time of filing, and/or as developed after the time of filing.

In one embodiment, the positions of one or more mobile devices associated with one or more consumers are tracked by obtaining data regarding the position of the one or more mobile devices at two or more times and then using the data regarding the position of the one or more mobile devices at two or more times to calculate an estimated direction/path and speed of the one or more consumers using one or more processors associated with one or more computing systems. In one embodiment, the positions of one or more mobile devices associated with one or more consumers are tracked by obtaining data regarding the position of the one or more mobile devices at regular intervals, such as every second, every few seconds, every minute, every few minutes, etc. and then estimating, and updating and/or refining the estimated direction/path and speed of the one or more consumers accordingly using one or more processors associated with one or more computing systems.

In various embodiments, one or more of the one or more mobile devices are associated with consumers traveling by car, bicycle, train, bus, or any other vehicle in an relatively open environment, such as outside, or in a relatively closed environment, such as a mall, stadium, or shopping center. In various embodiments, one or more of the one or more mobile devices are associated with consumers traveling by foot in a relatively open environment, such as outside, or in a relatively closed environment, such as a mall, stadium, or shopping center.

In various embodiments, the position of the one or more mobile devices is determined based on analysis of a communication signal emitted by the mobile devices and/or the relay stations used by the mobile devices. In various embodiments, the position of the one or more mobile devices is determined using a Global Positioning Satellite (GPS) system and/or a GPS capability provided with the one or more mobile devices. In various embodiments, the position of the one or more mobile devices is provided by the one or more mobile devices themselves via one or more data links. In various embodiments, the position of the one or more mobile devices is determined and/or provided by any method, means, mechanism, or procedure for determining a position of a mobile device as discussed herein, and/or as known in the art at the time of filing, and/or as developed after the time of filing.

Numerous means, methods, equations, algorithms, procedures and processes are known in the art for calculating an estimated direction/path and speed using two or more positions taken at different times. Consequently, a more detailed discussion of any particular means, methods, equations, algorithms, procedures and processes for calculating an estimated direction/path and speed of one or more consumers using two or more positions taken at different times is omitted here to avoid detracting from the invention.

As noted above, in one embodiment, the data regarding the position of the one or more mobile devices at two or more times is used to calculate, and/or update, an estimated direction/path and speed of the one or more consumers. In one embodiment, the data regarding the position of the one or more mobile devices at two or more times is used to calculate, and/or update, an estimated direction/path and speed of the one or more consumers and then the estimated direction/path for a given customer is modified based on data particular to the customer such as data obtained from a customer's calendar application, in one embodiment as implemented on the mobile device, indicating a time and place of a meeting. In one embodiment this calendar data is then used to refine the estimated direction/path and speed for the given customer based on where the customer needs to be at a given time.

In one embodiment, the business related data associated with each of the participating businesses, as stored in one embodiment in a participating business database, is searched to determine which participating businesses are within a defined distance of the estimated direction/path of the of the one or more mobile devices, and therefore of the one or more consumers associated with the one or more mobile devices. In one embodiment, a probability of a particular consumer passing within a defined distance of a particular participating business is calculated for each consumer/participating business pairing.

In one embodiment, a probability that one or more of the one or more consumers will respond to an offer or advertisement for a particular participating business is then determined based, at least in part on the estimated direction/path of the consumers and the financial data associated with the one or more consumers. In one embodiment, a probability that one or more of the one or more consumers will respond to an offer or advertisement for a particular participating business is determined based, at least in part, on one or more probability of use parameters.

In one embodiment, the probability that one or more of the one or more consumers will respond to an offer or advertisement for a particular participating business is determined based, at least in part, on a proximity probability of use parameter indicating how close the estimated direction/path of a consumer brings the consumer to a particular participating business. In one embodiment, the closer the estimated direction/path of a consumer brings the consumer to a particular participating business, the greater the probability that the consumer will utilize the particular participating business in response to an offer or advertisement.

For instance, as a specific illustrative example, if it is determined that the estimated direction/path of a consumer brings the consumer within 100 yards of a Starbucks coffee shop, then the probability that the consumer will utilize the Starbucks coffee shop, i.e., purchase a product sold by the Starbucks coffee shop in response to an offer or advertisement, would be considered higher than if the estimated direction/path of a consumer brings the consumer within between 100 yards and 1000 yards of a Starbucks coffee shop.

In one embodiment, the probability that one or more of the one or more consumers will respond to an offer or advertisement for a particular participating business is determined based, at least in part, on a proximity probability of use parameter and generalized statistical consumer usage data such as data indicating, on average, what percentage of consumers who pass by a given business type offering products and/or services similar to a particular participating business are statistically likely to utilize the given business type in response to an offer or advertisement.

For instance, as a specific illustrative example, if it is determined that the estimated direction/path of a consumer brings the consumer within 100 yards of a Starbucks coffee shop, and statistics show that, on average, 5% of consumers who see a Starbucks coffee shop utilize the Starbucks coffee shop, then this data is used to help determine the probability that a consumer will utilize the Starbucks coffee shop in response to an offer or advertisement.

In one embodiment, the probability that one or more of the one or more consumers will respond to an offer or advertisement for a particular participating business is determined based, at least in part, on a proximity probability of use parameter and generalized statistical consumer usage data modified based on time of the time of day, day of the week, or date.

For instance, as a specific illustrative example, if it is determined that the estimated direction/path of a consumer, traveling at a determined/estimated speed, brings the consumer within 100 yards of a Starbucks coffee shop, and statistics show that, on average, 15% of consumers who see a Starbucks coffee shop utilize the Starbucks coffee shop between the hours of 6 AM and 10 AM while, on average, only 1% of consumers who see a Starbucks coffee shop utilize the Starbucks coffee shop between the hours of 10 AM and 10 PM, then this data, along with data indicating the local time of day, is used to help determine the probability that a consumer will utilize the Starbucks coffee shop in response to an offer or advertisement.

In one embodiment, the personalized probability of use parameters are derived from the financial data associated with the consumer, in one embodiment, as implemented and/or accessed on the mobile device, indicating whether the consumer has historically utilized the particular participating business, or businesses offering products and/or services similar to the products and/or services offered by the particular participating business, and/or if the consumer has a preference for one or another business of businesses offering similar products and/or services, such as a preference for Starbucks coffee over Peet's coffee.

In one embodiment, the personalized probability of use parameters are derived from the financial data associated with the consumer, indicating whether the consumer has historically utilized the particular participating business, or businesses offering products and/or services similar to the products and/or services offered by the particular participating business at the determined time of day, day of the week, or date, and/or if the consumer has a preference for one or another business of businesses offering similar products and/or services, such as a preference for Starbucks coffee over Peet's coffee.

In one embodiment, the personalized probability of use parameters are derived from the financial data associated with the consumer, indicating whether there are one or more defined financial indicators associated with the consumer such as, but not limited to: defined expenditures in one or more defined financial categories; defined assets; defined account balances; defined memberships; defined demographic parameters; defined levels of income and/or “disposable income”; and/or any other financial indicators defined by the provider of the process for providing targeted advertisements based on positional tracking of mobile devices and financial data and/or one or more consumers and that can be derived from the financial data associated with consumers.

In one embodiment, the personalized probability of use parameters are derived from data specific to a given consumer such as, but not limited to, data obtained from a consumer's calendar application, in one embodiment as implemented and/or accessed on the mobile device, indicating a time and place of a meeting and/or whether the customer has historically utilized the particular participating business, or businesses offering products and/or services similar to the products and/or services offered by the particular participating business, and/or if the consumer has time to respond to an offer or advertisement for a particular participating business.

In one embodiment, the personalized probability of use parameters are derived from data specific to a given consumer such as, but not limited to, historical positional data associated with the mobile device and the consumer, in one embodiment as implemented and/or accessed and/or stored on the mobile device, indicating whether the consumer has historically utilized the particular participating business, or businesses offering products and/or services similar to the products and/or services offered by the particular participating business.

In one embodiment, the personalized probability of use parameters are derived from data specific to a given consumer such as, but not limited to, historical positional data associated with the mobile device and the consumer, in one embodiment as implemented and/or accessed and/or stored on the mobile device, indicating whether the consumer has historically utilized the particular participating business, or businesses offering products and/or services similar to the products and/or services offered by the particular participating business at the determined time of day, day of the week, or date; and/or any other data specific to a given consumer defined by the process for providing targeted advertisements based on positional tracking of mobile devices and financial data and/or one or more participating businesses.

In one embodiment, any of the probability of use parameters, or combination of probability of use parameters, discussed above, or any other probability of use parameters defined by the process for providing targeted advertisements based on positional tracking of mobile devices and financial data and/or one or more participating businesses, are used to determine, and/or refine, a probability that one or more of the one or more consumers will respond to an offer or advertisement for a particular participating business.

Numerous means, methods, equations, algorithms, procedures and processes are known in the art for calculating probabilities and probability functions based on one or more parameters and/or variables. Consequently, a more detailed discussion of any particular means, methods, equations, algorithms, procedures and processes for determining the probability that one or more of the one or more consumers will respond to an offer or advertisement for a particular participating business using one of more probability of use parameters is omitted here to avoid detracting from the invention.

In one embodiment, a probability score is calculated for each participating business/consumer pair that indicates a probability that a particular consumer will respond to an offer or advertisement for a particular participating business in a defined time frame.

In one embodiment, a threshold probability score is defined for each participating business such that any consumer having a probability score associated with a particular participating business that is greater than the defined threshold probability score is deemed probable to utilize the particular participating business. For instance, as a specific illustrative example, a threshold probability score of 34% may be defined for a particular Starbucks coffee shop. Then any consumer having a probability score of 34% or greater is determined a probable consumer, i.e., a consumer probable to become customer of the particular Starbucks coffee shop in response to an offer or advertisement.

In various embodiments, a given consumer is deemed probable to utilize the particular participating business in response to an offer or advertisement using any other criteria as discussed herein, and/or as known in the art at the time of filing, and/or as developed after the time of filing.

In various embodiments, all tracked consumers are deemed probable to utilize the particular participating business in response to an offer or advertisement, albeit with a wide range of probabilities extending from very low to relatively high. In various embodiments, any desired sub-set of tracked consumers is deemed probable to utilize the particular participating business in response to an offer or advertisement.

As discussed in more detail below, in one embodiment, the probability of use parameters and/or data associated with a particular consumer is used to create offers and/or information customized, or tailored, to the given consumer to maximize the probability that the particular consumer will respond to the offer or advertisement for a particular participating business.

As noted above, in one embodiment, the data regarding the position of the one or more mobile devices, and, in some embodiments, various data specific to a given consumer, is used to calculate, and/or update, an estimated direction/path and speed for the one or more consumers. In one embodiment, the estimated direction/path and speed for the one or more consumers is used to calculate, and/or update, estimated arrival times of one or more of the one or more consumers at a point closest to the particular participating business. In one embodiment, the estimated direction/path and speed for the one or more consumers is used to calculate, and/or update, estimated arrival times at the point closest to the particular participating business of only those consumers deemed probable to utilize the particular participating business in response to an offer or advertisement.

In one embodiment, the participating businesses are then provided the opportunity to send one or more of the consumers one or more offers and/or information regarding the participating businesses that can include, but are not limited to, an advertisement, a coupon, and/or any other marketing device, and/or electronic media based advertisement and/or marketing device.

In one embodiment, the participating businesses are given the opportunity to provide the consumers with offers and/or information regarding their products or services through the mobile devices associated with the consumers.

In one embodiment, the offers and/or information are provided to the consumers on a display device of the mobile devices associated with the consumers.

As a specific illustrative example, in one embodiment, the participating businesses are given the opportunity to provide the consumers with offers and/or information regarding their products or services through an SMS mobile computing system based marketing device such as a coupon or discount voucher or any other marketing device as discussed herein, and/or as known in the art at the time of filing, and/or as developed after the time of filing.

In one embodiment, the offers and/or information are provided to the consumers through the financial management system.

As noted above, in various embodiments, the offers and/or information regarding the products or services offered by the participating businesses can include, but are not limited to an advertisement, a marketing device, and/or an electronic media based advertisement and/or marketing device.

Herein, the term “advertisement” includes, but is not limited to, any advertisement and/or marketing device in digital, text, visual, audio, or other format presented, and/or offered to, and/or obtained by, a consumer/user and/or a consumer's/user's agents and designed to encourage some form of consumer action.

Herein, the term “marketing device” includes, but is not limited to: coupons; discount certificates; price guarantees; package/upgrade vouchers; group discount vouchers; multiple “for the price of one” offers/vouchers; advertisements; sales offers; and/or any other marketing tool and/or device and/or offer that is presented, and/or offered to, and/or obtained by, a consumer/user and/or a consumer's/user's agents and is designed to encourage some form of consumer action.

Herein, the term “electronic media based advertisement and/or marketing device” is used to denote any advertisement and/or marketing device distributed primarily, and/or initially, as electronic data by any method and/or mechanism for distributing electronic media based advertisements and/or marketing devices as discussed herein, and/or as known in the art at the time of filing, and/or as developed/made available after the time of filing.

In one embodiment, the offers and/or information are provided to the consumers through any data link as discussed herein, and/or as known in the art at the time of filing, and/or as developed after the time of filing.

In one embodiment, the offers and/or information are provided to the consumers through one or more databases, as discussed herein, and/or as known in the art at the time of filing, and/or as developed after the time of filing.

In one embodiment, the offers and/or information are provided to the consumers through one or more mobile communication networks, as discussed herein, and/or as known in the art at the time of filing, and/or as developed after the time of filing.

In one embodiment, the offers and/or information are provided to the consumers through one or more networks, as discussed herein, and/or as known in the art at the time of filing, and/or as developed after the time of filing.

In one embodiment, the offers and/or information are provided to the consumers using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

As noted above, in one embodiment, the probability of use parameters and/or data associated with a particular consumer is used to create offers and/or information customized, or tailored, to the given consumer to maximize the probability that the particular consumer will respond to the offer or advertisement for a particular participating business.

As also noted above, in one embodiment, the data regarding the position of the one or more mobile devices, and, in some embodiments, various data specific to a given consumer, is used to calculate, and/or update, an estimated direction/path and speed for the one or more consumers and estimated arrival times of one or more of the one or more consumers at a point closest to the particular participating business. In one embodiment, the estimated direction/path and speed and estimated arrival times at the point closest to the particular participating business is used to calculate an estimated best, or “ideal” time to send the one or more offers and/or information regarding the participating business to a given consumer.

In one embodiment, a probability that a given offer and/or information regarding a given participating business will effect a given consumer, i.e., cause the given consumer to become a customer, is calculated and provided to the participating business. In one embodiment, the probabilities that a given offer and/or information regarding a given participating business delivered at specific times will effect a given consumer, i.e., cause the given consumer to become a customer, is calculated and provided to the participating business for one or more specific times.

In one embodiment, the one or more offers and/or information regarding the participating business are monitored and results are correlated to obtain usage/redemption feedback data that is then used to refine future recommendations and track the effectiveness of the various offers and/or information disseminated and/or for specific consumers, times and dates.

### Hardware Architecture

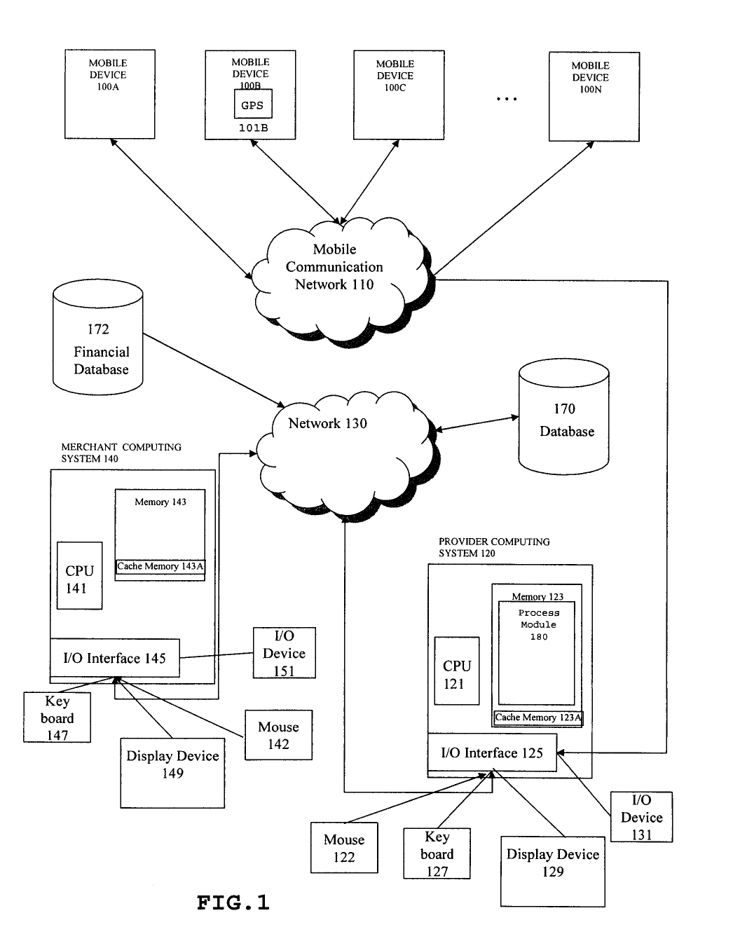

FIG. 1 is a block diagram of an exemplary hardware architecture for implementing one embodiment of a system and method for providing targeted advertisements based on positional tracking of mobile devices and financial data, such as exemplary process 300 discussed herein, that includes: “N” mobile devices 100A, 100B, 100C, . . . 100N, e.g., mobile “computing systems”; a mobile communication network 110; a provider computing system 120, e.g. a first computing system; a merchant computing system 140, e.g. a second computing system; a financial database 172; and a database 170, all operatively coupled by a network 130.

As noted above, herein, the term “mobile device”, as used in the term mobile devices 100A through 100N, includes, but is not limited to: a mobile “computing system”; a portable computer; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device and/or computing system that includes components that can execute all, or part, of any one of the processes and/or operations as described herein. In addition, as used herein, the term mobile device, can denote, but is not limited to, computing systems made up of multiple: wireless devices; cellular telephones; digital telephones; two-way pagers; PDAs; media players; or any desired combination of these devices and/or computing systems, that are coupled to perform the processes and/or operations as described herein.

In various embodiments, mobile devices 100A through 100N are associated with one or more consumers. As also seen in FIG. 1, in various embodiments, one or mobile devices 100A through 100N include positional capabilities, such as illustrative GPS 101B shown as being associated with mobile device 100B.

As also shown in FIG. 1, in one embodiment, mobile devices 100A through 100N are connected by mobile communication network 110. In various embodiments, mobile communication network 110 is representative of multiple mobile communication networks.

As noted above, in various embodiments, mobile communication network 110 can be, but is not limited to: any general network, communications network, or general network/communications network system; a cellular network; a wireless network; a combination of different network types, or other wireless, wired, and/or a wireless and wired combination network; a public network; a private network; a satellite network; a cable network; or any other network capable of allowing communication between two or more mobile devices and/or computing systems, as discussed herein, and/or available or known at the time of filing, and/or as developed after the time of filing.

Also shown in FIG. 1 is provider computing system 120. In various embodiments, provider computing system 120 is under the control of, accessible by, or otherwise associated with, a provider of process for providing targeted advertisements based on positional tracking of mobile devices and financial data and is used to implement at least part of a process for providing targeted advertisements based on positional tracking of mobile devices and financial data.

As shown in FIG. 1, provider computing system 120 typically includes a central processing unit (CPU) 121, an input/output (I/O) interface 125, and a memory system 123, including cache memory 123A. In one embodiment, memory system 123 includes all, or part of, a process module 180 for implementing at least part of a process for providing targeted advertisements based on positional tracking of mobile devices and financial data, such as exemplary process 300 discussed below.

Provider computing system 120 may further include standard user interface devices such as a keyboard 127, a mouse 122, and a display device 129, as well as, one or more standard input/output (I/O) devices 131, such as a compact disk (CD) or Digital Video Disc (DVD) drive, floppy disk drive, or other digital or waveform port, or other device capable of inputting data to, and outputting data from, provider computing system 120, whether available or known at the time of filing or as later developed.

In one embodiment, all, or part of: a process for providing targeted advertisements based on positional tracking of mobile devices and financial data; business data associated with one or more participating businesses; data representing one or more estimated consumer paths and speeds; data identifying one or more mobile devices associated with one or more consumers; financial data associated with one or more consumers; data linking or more mobile devices associated with one or more consumers with financial data associated with the one or more consumers; data representing one or more offers and/or advertisements and/or product/service information; and/or various analysis data associated with process for providing targeted advertisements based on positional tracking of mobile devices and financial data is stored, in whole, or in part, in memory 123 of provider computing system 120.

In one embodiment, all, or part of: a process for providing targeted advertisements based on positional tracking of mobile devices and financial data; business data associated with one or more participating businesses; data representing one or more estimated consumer paths and speeds; data identifying one or more mobile devices associated with one or more consumers; financial data associated with one or more consumers; data linking or more mobile devices associated with one or more consumers with financial data associated with the one or more consumers; data representing one or more offers and/or advertisements and/or product/service information; and/or various analysis data associated with process for providing targeted advertisements based on positional tracking of mobile devices and financial data is/are entered, in whole, or in part, into provider computing system 120 via I/O device 131, such as from a CD, DVD, floppy disk, portable hard drive, memory stick, download site, or other medium and/or computer program product as defined herein.

As noted above, as used herein, the term “computing system” includes, but is not limited to: a desktop computing system/computer; a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

In one embodiment, provider computing system 120 is representative of two or more computing systems. In one embodiment, provider computing system 120 is a client computing system associated with one or more server computing systems. In one embodiment, provider computing system 120 is a server computing system that is, in turn, associated with one or more client computing systems. In one embodiment, provider computing system 120 is part of a cloud computing environment.

In one embodiment, provider computing system 120 is operatively coupled to mobile communication network 110, and/or a provider of mobile communication network 110, such that provider computing system 120 can obtain position data associated with one or more of mobile computing systems 100A through 100N.

As also seen in FIG. 1, in one embodiment, merchant computing system 140 can include a CPU 141, an input/output (I/O) interface 145, and a memory system 143, including cache memory 143A. In one embodiment, merchant computing system 140 may further include standard user interface devices such as a keyboard 147, a mouse 142, and a display device 149, as well as, one or more standard input/output (I/O) devices 151, such as a compact disk (CD) or DVD drive, floppy disk drive, or other digital or waveform port, or other device capable of inputting data to, and outputting data from, merchant computing system 140, whether available or known at the time of filing or as later developed.

In one embodiment, merchant computing system 140 stores and/or processes all or part of: a process for providing targeted advertisements based on positional tracking of mobile devices and financial data; business data associated with one or more participating businesses; data representing one or more estimated consumer paths and speeds; data identifying one or more mobile devices associated with one or more consumers; financial data associated with one or more consumers; data linking or more mobile devices associated with one or more consumers with financial data associated with the one or more consumers; data representing one or more offers and/or advertisements and/or product/service information; and/or various analysis data associated with process for providing targeted advertisements based on positional tracking of mobile devices and financial data

In one embodiment, merchant computing system 140 is representative of multiple computing systems. In various embodiments, merchant computing system 140 can be any computing system as defined herein, and/or as known in the art at the time of filing, and/or as developed thereafter, that includes components that can execute all, or part, of a process for providing targeted advertisements based on positional tracking of mobile devices and financial data in accordance with at least one of the embodiments as described herein.

Also shown in FIG. 1 is database 170. In one embodiment, database 170 is a participating business database that includes at least part of business related data associated with one or more participating businesses.

In one embodiment, database 170 is a data storage device, a designated server system or computing system, or a designated portion of one or more server systems or computing systems, such as computing system(s) 120 and/or 140, or a distributed database, or an external and/or portable hard drive. In one embodiment, database 170 is a dedicated mass storage device implemented in software, hardware, or a combination of hardware and software.

In one embodiment, database 170 is a web-based function. As discussed in more detail below, in one embodiment, database 170 is under the control of, or otherwise accessible by, a process for providing targeted advertisements based on positional tracking of mobile devices and financial data. In one embodiment, database 170 is part of a cloud computing environment.

Also shown in FIG. 1 is financial database 172. In one embodiment, financial database 172 is a database that includes at least part of one or more of: data identifying one or more mobile devices associated with one or more consumers; financial data associated with one or more consumers; data linking or more mobile devices associated with one or more consumers with financial data associated with the one or more consumers; data representing one or more offers and/or advertisements and/or product/service information.

In one embodiment, financial database 172 is a database under the control of, accessible by, associated with, or implementing, one or more financial management systems.

In one embodiment, financial database 172 is a data storage device, a designated server system or computing system, or a designated portion of one or more server systems or computing systems, such as computing system(s) 120 and/or 140, or a distributed database, or an external and/or portable hard drive. In one embodiment, financial database 172 is a dedicated mass storage device implemented in software, hardware, or a combination of hardware and software.

In one embodiment, financial database 172 is part of a cloud computing environment.

In one embodiment, provider computing system 120, merchant computing system 140, database 170, and financial database 172 are coupled through network 130. In various embodiments, network 130 is any network, communications network, or network/communications network system such as, but not limited to: any general network, communications network, or general network/communications network system; a cellular network; a wireless network; a combination of different network types, or other wireless, wired, and/or a wireless and wired combination network; a public network; a private network; a satellite network; a cable network; or any other network capable of allowing communication between two or more computing systems, as discussed herein, and/or available or known at the time of filing, and/or as developed after the time of filing.

Those of skill in the art will readily recognize that the components shown in FIG. 1, such as mobile devices 100A through 100N, provider computing system 120, merchant computing system 140, financial database 172, and database 170, and their respective components, are shown for illustrative purposes only and that architectures with more or fewer components can implement, and benefit from, the invention. Moreover, one or more components of mobile devices 100A through 100N, provider computing system 120, merchant computing system 140, financial database 172, and database 170 may be located remotely from their respective system and accessed via network, as discussed herein. In addition, the particular type of, and configuration of, mobile devices 100A through 100N, provider computing system 120, merchant computing system 140, financial database 172, and database 170 are not relevant.

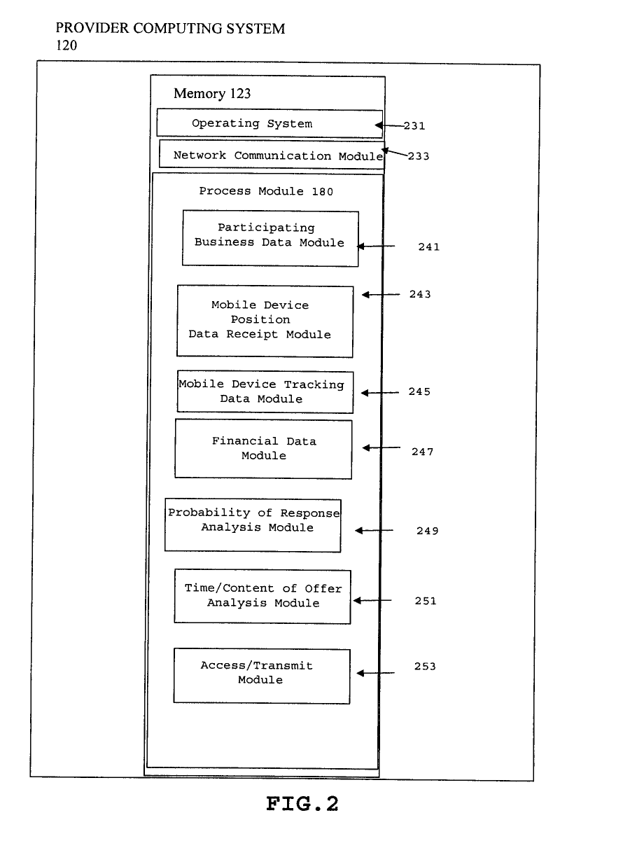

FIG. 2 is a more detailed block diagram of memory system 123 of provider computing system 120 of FIG. 1. As seen in FIG. 2, memory system 123 can store data and/or instructions associated with, but not limited to, the following elements, subsets of elements, and/or super-sets of elements for processing by one or more processors: operating system 231 that includes procedures, data, and/or instructions for handling various services and performing/coordinating hardware dependent tasks; network communications module 233 that includes procedures, data, and/or instructions, for connecting provider computing system 120 to other computing systems, such as merchant computing system 140 of FIG. 1, and/or one or more networks, such as mobile communications network 110 and/or network 130 of FIG. 1, and/or a database, such as financial database 172 and/or database 170 of FIG. 1; and process module 180 that includes procedures, data, and/or instructions, associated with a process for providing targeted advertisements based on positional tracking of mobile devices and financial data.

As also seen in FIG. 2, process module 180 includes participating business data module 241 that includes procedures, data, and/or instructions, for obtaining and/or storing business related data associated with one or more participating busses including, but not limited to, one or more of data indicating the participating business name; the participating business location; products/services provided by the participating business; the participating business hours of operation; various logistical data associated with the participating business such as parking availability, seating capacity, etc.; and/or any other data associated with the participating business desired by the provider of the process for providing targeted advertisements based on positional tracking of mobile devices and financial data and/or one or more businesses.

As also seen in FIG. 2, in one embodiment, process module 180 includes mobile device position data receipt module 243 that includes procedures, data, and/or instructions, for obtaining and/or storing data indicating the positions of one or more mobile devices associated with one or more consumers at various times.

As also seen in FIG. 2, in one embodiment, process module 180 includes mobile device tracking data module 245 that includes procedures, data, and/or instructions, for determining an estimated direction/path and speed of the one or more consumers using the data indicating the positions of one or more mobile devices associated with one or more consumers at various times of mobile device position data receipt module 243.

As also seen in FIG. 2, in one embodiment, process module 180 includes financial data module 247 that includes procedures, data, and/or instructions, for obtaining, accessing, and/or storing financial data associated with one or more consumers.

As also seen in FIG. 2, in one embodiment, process module 180 includes probability of response analysis module 249 that includes procedures, data, and/or instructions, for determining a probability that a consumer will respond to an offer or advertisement for a particular participating business, and/or an offer or advertisement associated with specific products and/or services associated with a particular participating business.

As also seen in FIG. 2, in one embodiment, process module 180 includes time/content of offer analysis module 251 that includes procedures, data, and/or instructions, for determining an optimum time of dissemination and/or content for a given offer and/or advertisement to be sent to a given consumer.

As also seen in FIG. 2, in one embodiment, process module 180 includes access/transmit module 249 that includes procedures, data, and/or instructions, for providing subscribing ones of the one or more participating businesses the capability to make one or more offers and/or advertisements to one or more consumers and to transmit data representing the one or more offers and/or advertisements to one or more consumers.

Those of skill in the art will readily recognize that the choice of components, data, modules, and information shown in FIG. 2, the organization of the components, data, modules, and information shown in FIG. 2, and the manner of storage and location of storage of the data, modules, and information shown in FIG. 2 was made for illustrative purposes only and that other choices of components, data, modules, and information, organization of the components, data, modules, and information, manner of storing, and location of storage, of the data, modules, and information can be implemented without departing from the scope of the invention as set forth in the claims below. In particular, the various modules and/or data shown in FIG. 2 are illustrative only and not limiting. In various other embodiments, the particular modules and/or data shown in FIG. 2 can be grouped together in fewer modules and/or data locations or divided among more modules and/or data locations. Consequently, those of skill in the art will recognize that other orders and/or grouping are possible and the particular modules and/or data, order, and/or grouping shown in FIG. 2 discussed herein do not limit the scope as claimed below.

### Process

In accordance with one embodiment, a method and system for providing targeted advertisements based on positional tracking of mobile devices and financial data includes a process for providing targeted advertisements based on positional tracking of mobile devices and financial data whereby, in one embodiment, data associated with one or more participating businesses is obtained including, but not limited to, data indicating one or more of: the business name; the business location; and/or products/services provided by the business. In one embodiment a mobile device associated with a consumer is linked, or otherwise associated with, financial data associated with the consumer obtained, in one embodiment, from a financial management system used by the consumer. In one embodiment, the position of the mobile device associated with the consumer is tracked and an estimated direction/path and speed of the consumer is thereby determined. In one embodiment, a probability that the consumer will respond to an offer or advertisement for a particular participating business, and/or an offer or advertisement associated with specific products and/or services associated with a particular participating business, is then determined for the consumer based, at least in part on, but not limited to, one or more of the following probability of use parameters: how close the estimated direction/path of a consumer brings the consumer to the particular participating business; generalized consumer usage data; the time of day, day of the week, or date; personalized consumer usage data such as whether the consumer has historically utilized the particular participating business, or businesses offering products and/or services similar to the products and/or services offered by the particular participating business, and/or whether the consumer has historically utilized the particular participating business, or businesses offering products and/or services similar to the products and/or services offered by the particular participating business, at the determined time of day, day of the week, or date; or any other probability of use parameter, or combination of probability of use parameters, defined by the process for providing targeted advertisements based on positional tracking of mobile devices and financial data and/or one or more participating businesses. In one embodiment, the consumer's estimated arrival time at the closest point in the vicinity of the particular participating business is then calculated, and/or updated, using the tracked position of the mobile device associated with the consumer and/or the estimated direction/path and speed of the consumer. In one embodiment, the participating business is then provided the opportunity to send the consumer one or more offers and/or information regarding the participating business that can include, but are not limited to, an advertisement, a coupon, and/or any other marketing device, and/or electronic media based advertisement and/or marketing device. In one embodiment, the one or more offers and/or information regarding the participating business are provided to the consumer through the mobile device associated with the consumer. In one embodiment, the participating business is provided information regarding the calculated best time to send the consumer the one or more offers and/or information regarding the participating business to maximize the probability that the one or more offers and/or information will result in the consumer utilizing the participating business, i.e., to maximize the consumer's probability of use. In one embodiment, the one or more offers and/or information regarding the participating business are monitored to obtain usage/redemption feedback data that is then used to refine future recommendations and track the effectiveness of the various offers and/or information disseminated.

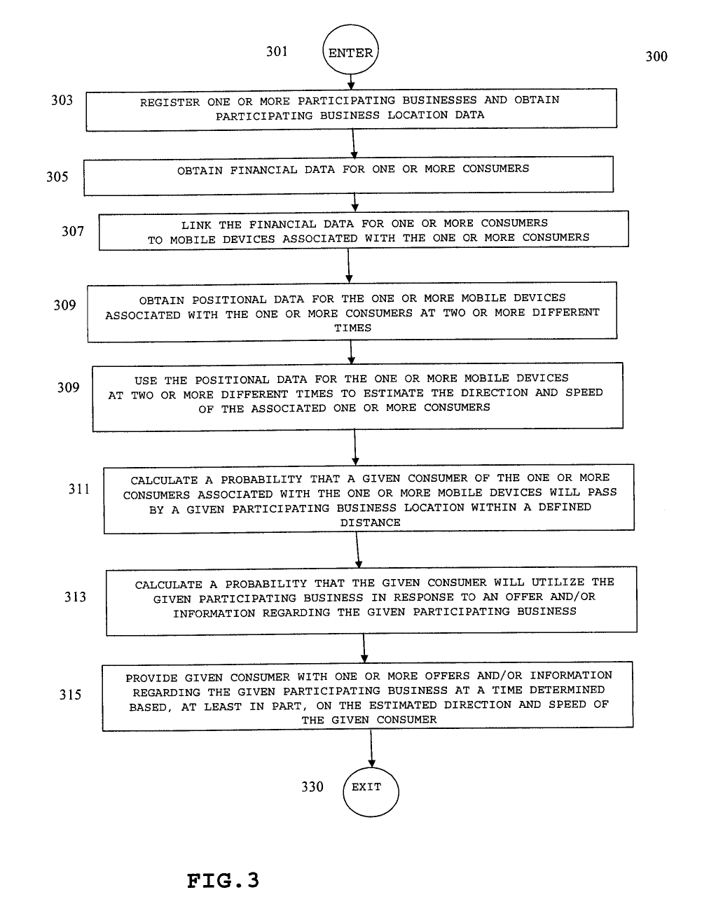

FIG. 3 is a flow chart depicting a process for providing targeted advertisements based on positional tracking of mobile devices and financial data 300 in accordance with one embodiment. Process for providing targeted advertisements based on positional tracking of mobile devices and financial data 300 begins at ENTER OPERATION 301 of FIG. 3 and process flow proceeds to REGISTER ONE OR MORE PARTICIPATING BUSINESSES AND OBTAIN PARTICIPATING BUSINESS LOCATION DATA OPERATION 303.

In one embodiment, at REGISTER ONE OR MORE PARTICIPATING BUSINESSES AND OBTAIN PARTICIPATING BUSINESS LOCATION DATA OPERATION 303 one or more participating businesses are registered with and/or subscribe to process for providing targeted advertisements based on positional tracking of mobile devices and financial data 300 and/or various business related data associated with one or more participating businesses is obtained by process for providing targeted advertisements based on positional tracking of mobile devices and financial data 300.

In one embodiment, at REGISTER ONE OR MORE PARTICIPATING BUSINESSES AND OBTAIN PARTICIPATING BUSINESS LOCATION DATA OPERATION 303 as part of the subscription/registration process, the one or more participating businesses provide process for providing targeted advertisements based on positional tracking of mobile devices and financial data 300 business related data including, but not limited to, one or more of data indicating: the participating business name; the participating business location; products/services provided by the participating business; the participating business hours of operation; various logistical data associated with the participating business such as parking availability, seating capacity, etc.; and/or any other data associated with the participating business desired by the provider of process for providing targeted advertisements based on positional tracking of mobile devices and financial data 300 and/or one or more businesses.

In one embodiment, at REGISTER ONE OR MORE PARTICIPATING BUSINESSES AND OBTAIN PARTICIPATING BUSINESS LOCATION DATA OPERATION 303 a participating business provides their business related data via one or more user interface screens displayed on one or more display devices associated with one or more merchant computing systems, such as display device 149 of merchant computing system 140 of FIG. 1, that are/is controlled by, accessible by, or otherwise associated with, the participating business, a participating business owner, a participating business employee, or any agent for the participating business.

Returning to FIG. 3, In one embodiment, at REGISTER ONE OR MORE PARTICIPATING BUSINESSES AND OBTAIN PARTICIPATING BUSINESS LOCATION DATA OPERATION 303 the one or more participating businesses provide their business related data via one or more merchant computing systems and/or a user interface device such as a keyboard, such as keyboard 147 of FIG. 1, a mouse, such as mouse 142 of FIG. 1, a touchpad, voice command recognition system, or any other device capable of providing user input to a computing system or for translating user actions into computing system operations, whether available or known at the time of filing or as developed later.

Returning to FIG. 3, in one embodiment, at REGISTER ONE OR MORE PARTICIPATING BUSINESSES AND OBTAIN PARTICIPATING BUSINESS LOCATION DATA OPERATION 303 the business related data associated with each of the participating businesses is obtained by process for providing targeted advertisements based on positional tracking of mobile devices and financial data 300 via any network or network system such as network 130 of FIG. 1, and/or any network as discussed herein, and/or as available or known at the time of filing, and/or as later developed.

Returning to FIG. 3, in one embodiment, at REGISTER ONE OR MORE PARTICIPATING BUSINESSES AND OBTAIN PARTICIPATING BUSINESS LOCATION DATA OPERATION 303 the business related data associated with each of the participating businesses is obtained by process for providing targeted advertisements based on positional tracking of mobile devices and financial data 300 using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

In one embodiment, at REGISTER ONE OR MORE PARTICIPATING BUSINESSES AND OBTAIN PARTICIPATING BUSINESS LOCATION DATA OPERATION 303 the business related data associated with each of the participating businesses is obtained by process for providing targeted advertisements based on positional tracking of mobile devices and financial data 300 and then the data is stored in a participating business database, such as database 170 of FIG. 1, and/or any database as discussed herein, known at the time of filing, or as developed thereafter.

Returning to FIG. 3, in one embodiment, once one or more participating businesses are registered with, and/or subscribe to, process for providing targeted advertisements based on positional tracking of mobile devices and financial data 300 and/or various business related data associated with one or more participating businesses is obtained by process for providing targeted advertisements based on positional tracking of mobile devices and financial data 300 at REGISTER ONE OR MORE PARTICIPATING BUSINESSES AND OBTAIN PARTICIPATING BUSINESS LOCATION DATA OPERATION 303, process flow proceeds to OBTAIN FINANCIAL DATA FOR ONE OR MORE CONSUMERS OPERATION 305.

In one embodiment, at OBTAIN FINANCIAL DATA FOR ONE OR MORE CONSUMERS OPERATION 305 financial data associated with one of more consumers is obtained.

In one embodiment, at OBTAIN FINANCIAL DATA FOR ONE OR MORE CONSUMERS OPERATION 305 the financial data associated with one of more consumers is obtained from one or more sources.

In one embodiment, at OBTAIN FINANCIAL DATA FOR ONE OR MORE CONSUMERS OPERATION 305 the financial data associated with one of more consumers is obtained by process for providing targeted advertisements based on positional tracking of mobile devices and financial data 300 using/from a financial management system.

In one embodiment, at OBTAIN FINANCIAL DATA FOR ONE OR MORE CONSUMERS OPERATION 305 the financial data associated with one of more consumers includes financial data representing various financial transactions conducted by the one or more consumers.

In one embodiment, at OBTAIN FINANCIAL DATA FOR ONE OR MORE CONSUMERS OPERATION 305 the financial data associated with one of more consumers includes data associated with financial transactions conducted using multiple payment methods to provide as complete a set of consumer financial data as possible. For instance, in one embodiment, the one or more consumers' financial transaction data is obtained at OBTAIN FINANCIAL DATA FOR ONE OR MORE CONSUMERS OPERATION 305 from, but not limited to, any one or more of the following sources: banks; debit cards and/or accounts; credit unions; credit cards and/or accounts and/or credit card/account providers; asset accounts and/or asset account providers; or other financial resources, accounts and/or services used by the one or more consumers to pay for and/or conduct financial transactions.

In addition, in some embodiments, the one or more consumers' financial transaction data obtained at OBTAIN FINANCIAL DATA FOR ONE OR MORE CONSUMERS OPERATION 305 is obtained from multiple sources of the same type.

For instance, in one embodiment, the one or more consumers' financial transaction data is obtained at OBTAIN FINANCIAL DATA FOR ONE OR MORE CONSUMERS OPERATION 305 from: two or more banks; two or more debit cards and/or accounts; two or more credit unions; two or more credit cards and/or accounts and/or credit card/account providers; two or more asset accounts and/or asset account providers; and/or two or more other financial resources, accounts and/or services used by the one or more consumers to pay for and/or conduct financial transactions.

As noted above, in one embodiment, all, or part, of the one or more consumers' financial transaction data is obtained by process for providing targeted advertisements based on positional tracking of mobile devices and financial data 300 at OBTAIN FINANCIAL DATA FOR ONE OR MORE CONSUMERS OPERATION 305 from, or using, one or more financial management systems that implement, include, are accessed by, and/or are otherwise associated with process for providing targeted advertisements based on positional tracking of mobile devices and financial data 300.

In one embodiment, the one or more financial management systems are any one of various financial management systems including, but not limited to, any computing system implemented, on-line or web-based, system, package, program, module, or application that gathers financial data, has the capability to analyze and categorize at least part of the financial data into various reports or displays that are provided to the user, and includes financial transaction data associated with the user.

Types of financial management systems currently available include, but are not limited to any of the following: an on-line, or web-based, or computing system implemented personal or business financial management system, package, program, module, or application; an on-line, or web-based, or computing system implemented banking system, package, program, module, or application; an on-line, or web-based, or computing system implemented home or business inventory system, package, program, module, or application; an on-line, or web-based, or computing system implemented personal or business asset management system, package, program, module, or application; an on-line, or web-based, or computing system implemented personal or business accounting system, package, program, module, or application; or any of the numerous on-line, or web-based, or computing system implemented financial management systems as discussed herein, and/or as known in the art at the time of filing, and/or as developed after the time of filing.

Specific examples of financial management systems currently available include, but are not limited to: Quicken', available from Intuit Inc. of Mountain View, Calif.; Quicken Online™, available from Intuit Inc. of Mountain View, Calif.; Quickbooks™, available from Intuit Inc. of Mountain View, Calif.; Mint.com™, available from Intuit Inc. of Mountain View, Calif.; Microsoft Money', available from Microsoft, Inc. of Redmond, Wash.; or various other computing system implemented financial management systems discussed herein, or known to those of skill in the art at the time of filing, or as developed after the time of filing.

Financial management systems typically help consumers/users manage their finances by providing a centralized interface with banks, credit card companies, and other various financial institutions and/or accounts, for identifying, processing, storing, and categorizing consumer financial transactions and other consumer financial data. Currently, financial management systems typically obtain financial transaction information, such as payee identification, payee location, payment amount, date of the transaction, time of transaction, items purchased, the type of transaction, etc., via communication with banks, credit card providers, or other financial institutions, using electronic data transfer systems such as the Open Financial Exchange (OFX) specification, or various other systems for transferring financial transaction data.

As noted above, using financial management systems, the financial transaction information, payee identification, payee location, payment amount, date of the transaction, and other data is often used by the financial management system to categorize individual financial transactions as a particular type of income or expense. Some currently offered financial management systems then use this financial transaction information to track events, such as purchase events, and to provide various historical data reports or displays including “to date” data reports such as historical spending data reports in one or more particular categories.

In one embodiment, all, or part of, the financial transaction data obtained using one or more financial management systems is transferred, or otherwise made available to, process for providing targeted advertisements based on positional tracking of mobile devices and financial data 300 at OBTAIN FINANCIAL DATA FOR ONE OR MORE CONSUMERS OPERATION 305.

In one embodiment, all, or part, of the financial data associated with one of more consumers is obtained by process for providing targeted advertisements based on positional tracking of mobile devices and financial data 300 at OBTAIN FINANCIAL DATA FOR ONE OR MORE CONSUMERS OPERATION 305 from invoices/bills and/or receipt data provided to process for providing targeted advertisements based on positional tracking of mobile devices and financial data 300, and/or an associated financial management system, by one or more merchants and/or product and/or service providers. In one embodiment, the invoice/bill and/or receipt data includes “level 3” data indicating, among other things, the line item entry and product and/or service identification for each item purchased in the transaction.

As noted above, in one embodiment, process for providing targeted advertisements based on positional tracking of mobile devices and financial data 300 is associated with one or more financial management systems that implement, include, are accessed by, and/or are otherwise associated with process for providing targeted advertisements based on positional tracking of mobile devices and financial data 300. Some of these financial management systems provide the capability to obtain, receive, and/or process electronic copies of the invoices/receipts from one or more merchants and/or product and/or service providers, often in their specific formats, and then store the data for use by process for providing targeted advertisements based on positional tracking of mobile devices and financial data 300 in one of numerous locations by one of numerous methods known to those of skill in the art and/or as discussed herein.

In one embodiment, all, or part, of the financial data associated with one of more consumers is obtained by process for providing targeted advertisements based on positional tracking of mobile devices and financial data 300 and/or a financial management system, at OBTAIN FINANCIAL DATA FOR ONE OR MORE CONSUMERS OPERATION 305 from one or more of the following, either directly, or by using screen scraping technology, or a similar technology: websites sponsored by, controlled by, or associated with banks, debit cards and/or accounts, credit unions, credit cards and/or accounts, and/or credit card/account providers, asset accounts and/or asset account providers, or other financial resources, accounts and/or services used by a consumer to pay for and/or conduct financial transactions; and/or computing system implemented applications sponsored by, controlled by, or associated with banks, debit cards and/or accounts, credit unions, credit cards and/or accounts, and/or credit card/account providers, asset accounts and/or asset account providers, or other financial resources, accounts and/or services used by a consumer to pay for and/or conduct financial transactions.

In one embodiment, all, or part, of the financial data associated with one of more consumers is obtained by process for providing targeted advertisements based on positional tracking of mobile devices and financial data 300 and/or a financial management system, at OBTAIN FINANCIAL DATA FOR ONE OR MORE CONSUMERS OPERATION 305 from user input through a user interface device such as a keyboard, a mouse, a touchpad, voice command recognition system, or any other device capable of providing user input to a computing system or for translating user actions into computing system operations, whether available or known at the time of filing or as developed later.

In one embodiment, all, or part, of the financial data associated with one of more consumers is obtained by process for providing targeted advertisements based on positional tracking of mobile devices and financial data 300, and/or a financial management system, at OBTAIN FINANCIAL DATA FOR ONE OR MORE CONSUMERS OPERATION 305 from any combination of the above sources and/or from any other source of a consumer's financial data whether known at the time of filing or as developed thereafter.

In one embodiment, once the financial data associated with one of more consumers is obtained by process for providing targeted advertisements based on positional tracking of mobile devices and financial data 300, the data is stored in whole, or in part, in a database, such as financial database 172 of FIG. 1, maintained by, accessible by, owned by, or otherwise related to: process for providing targeted advertisements based on positional tracking of mobile devices and financial data 300, and/or a provider of process for providing targeted advertisements based on positional tracking of mobile devices and financial data 300; a financial management system, and/or a provider of a financial management system; or any other party, by any one of the numerous mechanisms known to those of skill in the art.

For instance, in one embodiment, the data, in whole, or in part, is stored in a memory system, such as memory system 123, or database, such as databases 170 and/or 172, of FIG. 1, or in a cache memory, or in any main memory or mass memory, associated with a computing system, such as computing systems 120 or 140 described above. In one embodiment, the data, in whole, or in part, is stored in any computing system and/or server system, or other device, in another location, or on/in a computer readable medium, and/or any other computer program product. In one embodiment, the data, in whole, or in part, is stored on a webpage, in a web-based system or on a public network such as the Internet.

Returning to FIG. 3, in some embodiments, the consumer's financial data stored as described above is maintained, in whole, or in part, by: process for providing targeted advertisements based on positional tracking of mobile devices and financial data 300, and/or a provider of process for providing targeted advertisements based on positional tracking of mobile devices and financial data 300; a financial management system, and/or a provider of a financial management system; a third party data storage institution; any third party service or institution; or any other parties. In some embodiments, access to financial data associated with the one or more consumers is then provided to process for providing targeted advertisements based on positional tracking of mobile devices and financial data 300, and/or a financial management system, by providing access to the data and/or providing the data on a computer program product.

In one embodiment, once financial data associated with one of more consumers is obtained at OBTAIN FINANCIAL DATA FOR ONE OR MORE CONSUMERS OPERATION 305, process flow proceeds to LINK THE FINANCIAL DATA FOR ONE OR MORE CONSUMERS TO MOBILE DEVICES ASSOCIATED WITH THE ONE OR MORE CONSUMERS OPERATION 307.

In one embodiment, at LINK THE FINANCIAL DATA FOR ONE OR MORE CONSUMERS TO MOBILE DEVICES ASSOCIATED WITH THE ONE OR MORE CONSUMERS OPERATION 307 one or more mobile devices associated with the one or more consumers of OBTAIN FINANCIAL DATA FOR ONE OR MORE CONSUMERS OPERATION 305 are linked, correlated to, or otherwise associated with, financial data associated with the consumers of OBTAIN FINANCIAL DATA FOR ONE OR MORE CONSUMERS OPERATION 305.

In one embodiment, at LINK THE FINANCIAL DATA FOR ONE OR MORE CONSUMERS TO MOBILE DEVICES ASSOCIATED WITH THE ONE OR MORE CONSUMERS OPERATION 307 the one or more mobile devices associated with the one or more consumers are linked, correlated to, or otherwise associated with, financial data associated with the consumers obtained from one or more financial management systems used by the consumers.

In one embodiment, at LINK THE FINANCIAL DATA FOR ONE OR MORE CONSUMERS TO MOBILE DEVICES ASSOCIATED WITH THE ONE OR MORE CONSUMERS OPERATION 307 data identifying a given mobile device associated with a given consumer, and/or data linking the given mobile device associated with a given consumer to financial data associated with the given consumer, and/or at least part of the financial data associated with the given consumer, is obtained and stored in a financial data database, such as financial database 172 of FIG. 1, and/or any database as discussed herein, and/or as known/available in the art at the time of filing, and/or as developed after the time of filing.

Numerous methods, means, mechanisms, processes, and procedures for linking identification data with other data are well known in the art. Consequently, specific methods, means, mechanisms, processes, and procedures for linking data identifying a given mobile device associated with a given consumer and financial data associated with the given consumer are omitted here to avoid detracting from the invention.

Returning to FIG. 3, in one embodiment, once one or more mobile devices associated with the one or more consumers of OBTAIN FINANCIAL DATA FOR ONE OR MORE CONSUMERS OPERATION 305 are linked, correlated to, or otherwise associated with, financial data associated with the consumers of OBTAIN FINANCIAL DATA FOR ONE OR MORE CONSUMERS OPERATION 305 at LINK THE FINANCIAL DATA FOR ONE OR MORE CONSUMERS TO MOBILE DEVICES ASSOCIATED WITH THE ONE OR MORE CONSUMERS OPERATION 307, process flow proceeds to OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309.

In one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the positions of the one or more mobile devices associated with one or more consumers of LINK THE FINANCIAL DATA FOR ONE OR MORE CONSUMERS TO MOBILE DEVICES ASSOCIATED WITH THE ONE OR MORE CONSUMERS OPERATION 307 are obtained at least two different times.

In one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the positions of one or more mobile devices, such as mobile devices 100A through 100N of FIG. 1, associated with one or more consumers, are obtained at least two different times.

Returning to FIG. 3, in one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the one or more mobile devices associated with one or more consumers are registered with process for providing targeted advertisements based on positional tracking of mobile devices and financial data 300 by any method, means, mechanism, or procedure for registering a computing system and/or device, as discussed herein, and/or available or known at the time of filing, and/or as developed after the time of filing.

In one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the one or more mobile devices associated with one or more consumers are not specifically registered with process for providing targeted advertisements based on positional tracking of mobile devices and financial data 300, but the positional data of the one or more mobile devices is obtained by process for predicting customer flow and arrival times 300 through one or more mobile communication networks, such as mobile communication network 110 of FIG. 1, and/or providers of one or more mobile communication networks.

Returning to FIG. 3, in one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the consumers are provided the option to receive offers and/or information regarding the products or services associated with the participating businesses. In one embodiment, the consumer must specifically agree to receive offers and/or information regarding the product or service associated with the participating businesses, i.e., the consumer must opt-in, in order to protect the consumer's privacy and any desire the consumer may have to avoid receiving such offers/information.

In one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the consumers agree to receive offers and/or information regarding products or services associated with one or more businesses and/or providers of products or services through a financial management system via user input through a user interface device such as a keyboard, mouse, touchpad, voice command recognition system, or any other device capable of providing user input to a computing system or for translating user actions into computing system operations, whether available or known at the time of filing or as developed later.

In one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the one or more mobile devices are connected by one or more mobile communication networks such as mobile communication network 110 of FIG. 1, and/or any mobile communication network as discussed herein, and/or available or known at the time of filing, and/or as developed after the time of filing.

Returning to FIG. 3, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the positions of the one or more mobile devices associated with the one or more consumers are tracked by obtaining data regarding the position of the one or more mobile devices multiple times.

In one embodiment, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the positions of one or more mobile devices associated with one or more consumers are obtained at regular defined intervals, such as every second, every few seconds, every minute, every few minutes, etc.

In various embodiments, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 one or more of the one or more mobile devices are associated with consumers traveling by car, bicycle, train, bus, or any other vehicle in an relatively open environment, such as outside, or in a relatively closed environment, such as a mall, stadium, or shopping center or any building or structure.

In various embodiments, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 one or more of the one or more mobile devices are associated with consumers traveling by foot in a relatively open environment, such as outside, or in a relatively closed environment, such as a mall, stadium, or shopping center or any building or structure.

In various embodiments, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the position of the one or more mobile devices is determined based on analysis of a communication signal emitted by the mobile devices and/or the relay stations used by the mobile devices.

In various embodiments, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the position of the one or more mobile devices is determined using a Global Positioning Satellite (GPS) system and/or a GPS capability, such as GPS 101B of FIG. 1, provided with the one or more mobile devices, such as mobile device 101B of FIG. 1.

Returning to FIG. 3, in various embodiments, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the position of the one or more mobile devices is provided by the one or more mobile devices themselves via one or more data links.

In various embodiments, at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 the position of the one or more mobile devices is determined, and/or provided, and/or obtained by any method, means, mechanism, or procedure for determining a position of a mobile device as discussed herein, and/or as known in the art at the time of filing, and/or as developed after the time of filing.

In one embodiment, once the positions of one or more mobile devices associated with one or more consumers are obtained at least two different times at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309, process flow proceeds to USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311.

In one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 the data regarding the position of the one or more mobile devices at two or more times of OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 is used to calculate, and/or update, an estimated direction/path and speed of the one or more consumers.

In one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 the positions of the one or more mobile devices associated with the one or more consumers are tracked by obtaining data regarding the position of the one or more mobile devices at two or more times at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 and using the data to calculate an estimated direction/path and speed of the one or more consumers using one or more processors associated with one or more computing systems, such as CPU 121 of FIG. 1.

Returning to FIG. 3, in one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 the positions of the one or more mobile devices associated with the one or more consumers are tracked by obtaining data regarding the position of the one or more mobile devices at defined intervals at OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 such as every second, every few seconds, every minute, every few minutes, etc. and then estimating and updating and/or refining the estimated direction/path and speed of the one or more consumers accordingly using one or more processors associated with one or more computing systems, such as CPU 121 of FIG. 1.

Numerous means, methods, equations, algorithms, procedures and processes are known in the art for calculating an estimated direction/path and speed using two or more positions taken at different times. Consequently, a more detailed discussion of any particular means, methods, equations, algorithms, procedures and processes for calculating an estimated direction/path and speed of one or more consumers using two or more positions taken at different times is omitted here to avoid detracting from the invention.

Returning to FIG. 3, in one embodiment, once the data regarding the position of the one or more mobile devices at two or more times of OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309 is used to calculate, and/or update, an estimated direction/path and speed of the one or more consumers at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311, process flow proceeds to CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313.

In one embodiment, at CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 the estimated direction/path and speed of the one or more consumers calculated at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 and the business related data associated with each of the participating businesses of REGISTER ONE OR MORE PARTICIPATING BUSINESSES AND OBTAIN PARTICIPATING BUSINESS LOCATION DATA OPERATION 303 are analyzed to determine which participating businesses are within a defined distance of the estimated direction/path of the of the one or more mobile devices, and therefore of the one or more consumers associated with the one or more mobile devices.

In one embodiment, at CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 the estimated direction/path and speed of the one or more consumers calculated at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 is modified based on data particular to each of the one or more customers, such as data obtained from a customer's calendar application.

In one embodiment, the customer's calendar application is implemented on, accessed by, or at least some of the data is stored on, the mobile device associated with the consumer and is therefore readily accessible. In one embodiment, the customer's calendar application data indicates a time and place of a meeting.

In one embodiment the calendar application data is then used to refine the estimated direction/path and speed for the given customer based on where the customer needs to be at a given time and/or is used to calculate and/or refine a probability that the customer will pass within a defined distance of a particular one of the one or more participating businesses.

In one embodiment, once the estimated direction/path and speed of the one or more consumers calculated at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 and the business related data associated with each of the participating businesses of REGISTER ONE OR MORE PARTICIPATING BUSINESSES AND OBTAIN PARTICIPATING BUSINESS LOCATION DATA OPERATION 303 are analyzed to determine which participating businesses are within a defined distance of the estimated direction/path of the of the one or more mobile devices, and therefore of the one or more consumers associated with the one or more mobile devices at CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313, process flow proceeds to CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 a probability that a given consumer of the one or more consumers associated with the one or more mobile devices of CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 will respond to an offer or advertisement for a particular participating business is determined based, at least in part, on the estimated direction/path of the consumers of USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 and the financial data associated with the one or more consumers of OBTAIN FINANCIAL DATA FOR ONE OR MORE CONSUMERS OPERATION 305.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 a probability that a given consumer of the one or more consumers associated with the one or more mobile devices of CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 will respond to an offer or advertisement for a particular participating business is determined based, at least in part, on one or more probability of use parameters.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 a probability that a given consumer of the one or more consumers associated with the one or more mobile devices of CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 will respond to an offer or advertisement for a particular participating business is determined based, at least in part, on a proximity probability of use parameter indicating how close the estimated direction/path of CALCULATE A PROBABILITY THAT ONE OR MORE OF THE ONE OR MORE CONSUMERS ASSOCIATED WITH THE ONE OR MORE MOBILE DEVICES WILL PASS BY A PARTICIPATING BUSINESS LOCATION WITHIN A DEFINED DISTANCE OPERATION 309 will bring a consumer to the given participating business.

In one embodiment, the closer the estimated direction/path of a consumer brings the consumer to the given participating business, the greater the probability that the consumer will utilize the given participating business.

For instance, as a specific illustrative example, if it is determined at CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 that the estimated direction/path of a consumer brings the consumer within 100 yards of a Starbucks coffee shop, then at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the probability that the consumer will utilize the Starbucks coffee shop, i.e., purchase a product sold by the Starbucks coffee shop, in response to an offer and/or advertisement would be considered higher than if the estimated direction/path of a consumer brings the consumer within between 100 yards and 1000 yards of a Starbucks coffee shop.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the probability that one or more of the one or more consumers will respond to an offer or advertisement for a particular participating business is determined based, at least in part, on a proximity probability of use parameter and generalized statistical consumer usage data such as data indicating, on average, what percentage of consumers who pass by a given business type offering products and/or services similar to the given participating business are statistically likely to utilize the given business type.

For instance, as a specific illustrative example, if it is determined that the estimated direction/path of a consumer brings the consumer within 100 yards of a Starbucks coffee shop, and statistics show that, on average, 50 of consumers who see a Starbucks coffee shop utilize the Starbucks coffee shop, then at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 this data is used to help determine the probability that a consumer will utilize the Starbucks coffee shop in response to an offer or advertisement for a particular participating business.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the probability that one or more of the one or more consumers will respond to an offer or advertisement for a particular participating business is determined based, at least in part, on a proximity probability of use parameter and generalized statistical consumer usage data as modified based on time of the time of day, day of the week, or date data.

For instance, as a specific illustrative example, if it is determined that the estimated direction/path of a consumer brings the consumer within 100 yards of a Starbucks coffee shop, and statistics show that, on average, 15% of consumers who see a Starbucks coffee shop utilize the Starbucks coffee shop between the hours of 6 AM and 10 AM while, on average, only 1% of consumers who see a Starbucks coffee shop utilize the Starbucks coffee shop between the hours of 10 AM and 10 PM, then at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 this data, along with data indicating the local time of day, is used to help determine the probability that a consumer will utilize the Starbucks coffee shop in response to an offer and/or advertisement.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the probability that one or more of the one or more consumers will utilize a given participating business in response to an offer and/or advertisement is determined based, at least in part, on a proximity probability of use parameter and personalized probability of use parameters.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the personalized probability of use parameters are derived from the financial data associated with the consumer of OBTAIN FINANCIAL DATA FOR ONE OR MORE CONSUMERS OPERATION 305

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the personalized probability of use parameters are derived from the financial data associated with the consumer of OBTAIN FINANCIAL DATA FOR ONE OR MORE CONSUMERS OPERATION 305 indicating whether the consumer has historically utilized the particular participating business, or businesses offering products and/or services similar to the products and/or services offered by the particular participating business, and/or if the consumer has a preference for one or another business of businesses offering similar products and/or services, such as a preference for Starbucks coffee over Peet's coffee.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the personalized probability of use parameters are derived from the financial data associated with the consumer of OBTAIN FINANCIAL DATA FOR ONE OR MORE CONSUMERS OPERATION 305 indicating whether the consumer has historically utilized the particular participating business, or businesses offering products and/or services similar to the products and/or services offered by the particular participating business at the determined time of day, day of the week, or date, and/or if the consumer has a preference for one or another business of businesses offering similar products and/or services, such as a preference for Starbucks coffee over Peet's coffee.

For instance, as a specific illustrative example, an estimated direction/path for a given consumer may indicate that the user will pass within 100 yards of a Peet's coffee shop and within 300 yards of a Starbucks coffee shop. In addition, in this specific illustrative example, the consumer's calendar data shows the consumer has time to stop for coffee before a scheduled meeting. In addition, in this specific illustrative example, the consumer' financial transactional data shows the consumer historically buys coffee around this time of day. Consequently, absent preference data, the consumer would be assigned a relatively high probability of utilizing a coffee shop in response to an offer and/or advertisement and, given that the Peet's coffee shop is three times closer that the Starbucks coffee shop, the probability of the consumer utilizing the Peet's coffee shop in response to an offer and/or advertisement would be calculated as the higher of the two. However, if the consumer' financial transactional data shows the consumer utilizes Starbucks coffee shops far more frequently than Peet's, then the probability of the consumer utilizing the Peet's coffee shop in response to an offer and/or advertisement would be calculated lower and the probability of the consumer utilizing the Starbucks coffee shop in response to an offer and/or advertisement would be calculated as higher. However, if the distance to the Starbucks is too much greater, or the offer for Peet's coffee has better terms, the probability of the consumer utilizing the Peet's coffee shop in response to an offer and/or advertisement could still be calculated as the higher of the two.

As shown in the example above, in one embodiment, the financial data is used in conjunction with the consumer's calendar data and/or data indicating the local time of day to determine whether the consumer has historically utilized the particular participating business, or businesses offering products and/or services similar to the products and/or services offered by the particular participating business at the determined time of day, day of the week, or date.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the personalized probability of use parameters are derived from the financial data associated with the consumer of OBTAIN FINANCIAL DATA FOR ONE OR MORE CONSUMERS OPERATION 305 indicating whether there are one or more defined financial indicators associated with the consumer such as, but not limited to: defined expenditures in one or more defined financial categories; defined assets; defined account balances; defined memberships; defined demographic parameters; defined levels of income and/or “disposable income”; and/or any other financial indicators defined by the provider of process for providing targeted advertisements based on positional tracking of mobile devices and financial data 300 and/or one or more consumers and that can be derived from the financial data associated with consumers.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the personalized probability of use parameters are derived from other data specific to a given consumer such as, but not limited to, data obtained from a consumer's calendar application.

For instance, in one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 data from the consumer's calendar application is used to determine a time and place of a meeting and/or whether the customer has historically utilized the given participating business, or businesses offering products and/or services similar to the products and/or services offered by the given participating business.

In addition, in one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 31 data from the consumer's calendar application is used to determine if the consumer has time to utilize a given participating business before a scheduled event such as a meeting.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 historical positional data associated with the mobile device and the consumer, in one embodiment as implemented and/or accessed and/or stored on the mobile device, is used to determine whether the consumer has historically utilized the given participating business, or businesses offering products and/or services similar to the products and/or services offered by the given participating business.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 historical positional data associated with the mobile device and the consumer is used in conjunction with the consumers calendar data and/or data indicating the local time of day to determine whether the consumer has historically utilized the particular participating business, or businesses offering products and/or services similar to the products and/or services offered by the particular participating business at the determined time of day, day of the week, or date.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 the personalized probability of use parameters are derived from real time customer input for prospective needs through various mechanisms such as voice, keyboard input, stylus or other means to record the needs of the customer associated with the mobile device, or those in the proximity of such consumer, such as passengers in a car. Such a statement preference of need, for example, “I would love to eat a pizza”, is then included in the set of factors, computing arrival probabilities in merchant establishments in the trajectory of the movement of the mobile device and the associated consumer.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 historical offer usage data for the consumer is used, and/or data indicating the terms of the offer or advertisement is used, to determine whether the consumer has historically utilized offers directed to particular participating business, or businesses offering products and/or services similar to the products and/or services offered by the particular participating business

As discussed in more detail below, in one embodiment, the probability of use parameters and/or data associated with a particular consumer is used to create offers and/or information customized, or tailored, to the given consumer to maximize the probability that the particular consumer will respond to the offer or advertisement for a particular participating business.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 any of the probability of use parameters, or combination of probability of use parameters, discussed above, or any other probability of use parameters defined by process for providing targeted advertisements based on positional tracking of mobile devices and financial data 300 and/or one or more participating businesses, are used to determine a probability that one or more of the one or more consumers will respond to an offer or advertisement for a particular participating business.

Numerous means, methods, equations, algorithms, procedures and processes are known in the art for calculating probabilities and probability functions based on one or more parameters and/or variables. Consequently, a more detailed discussion of any particular means, methods, equations, algorithms, procedures and processes for determining the probability that one or more of the one or more consumers will respond to an offer or advertisement for a particular participating business using one of more probability of use parameters is omitted here to avoid detracting from the invention.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 a probability score is calculated for each participating business/consumer pair that indicates a probability that a particular consumer will respond to an offer or advertisement for a particular participating business in a defined time frame.

In one embodiment, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 a threshold probability score is defined for each participating business such that any consumer having a probability score associated with a given participating business that is greater than the defined threshold probability score is deemed probable to respond to an offer or advertisement for a particular participating business in a defined time frame.

For instance, as a specific illustrative example, a threshold probability score of 34% may be defined for a given Starbucks coffee shop. Then any consumer having a probability score of 34% or greater is determined at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 to be probable to respond to an offer or advertisement for Starbucks in a defined time frame, i.e., is deemed a probable customer of the given Starbucks coffee shop and is therefore deemed a good candidate to receive an offer and/or advertisement.

In various embodiments, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 a given consumer is deemed probable to utilize the given participating business in response to an offer or advertisement using any other criteria as discussed herein, and/or as known in the art at the time of filing, and/or as developed after the time of filing.

In various embodiments, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 all tracked consumers are deemed probable to utilize the given participating business in response to an offer or advertisement, albeit with a wide range of probabilities extending from very low to relatively high. In various embodiments, any desired sub-set of tracked consumers is deemed probable to utilize the given participating business in response to an offer or advertisement.

In one embodiment, once a probability that a given consumer of the one or more consumers associated with the one or more mobile devices of CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 will respond to an offer or advertisement for a particular participating business is determined based, at least in part, on the estimated direction/path of the consumers of USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 and the financial data associated with the one or more consumers of OBTAIN FINANCIAL DATA FOR ONE OR MORE CONSUMERS OPERATION 305 and, in various embodiments on one or more probability of use parameters, at CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315, process flow proceeds to PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the participating businesses of CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 are provided the opportunity to send one or more of the consumers of CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 one or more offers and/or information regarding the participating businesses at a time determined, at least in part, on the estimated direction/path and speed of USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the participating businesses are given the opportunity to provide the consumers with offers and/or information regarding their products or services through the mobile devices associated with the consumers.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided to the consumers on a display device of the mobile devices associated with the consumers.

As a specific illustrative example, in one embodiment, the participating businesses are given the opportunity to provide the consumers with offers and/or information regarding their products or services through an SMS mobile computing system based marketing device such as a coupon or discount voucher or any other marketing device as discussed herein, and/or as known in the art at the time of filing, and/or as developed after the time of filing.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided to the consumers through a financial management system.

In various embodiments, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information regarding the products or services offered by the participating businesses can include, but are not limited to an advertisement, a marketing device, and/or an electronic media based advertisement and/or marketing device.

Herein, the term “advertisement” includes, but is not limited to, any advertisement and/or marketing device in digital, text, visual, audio, or other format presented, and/or offered to, and/or obtained by, a consumer/user and/or a consumer's/user's agents and designed to encourage some form of consumer action.

Herein, the term “marketing device” includes, but is not limited to: coupons; discount certificates; price guarantees; package/upgrade vouchers; group discount vouchers; multiple “for the price of one” offers/vouchers; advertisements; sales offers; and/or any other marketing tool and/or device and/or offer that is presented, and/or offered to, and/or obtained by, a consumer/user and/or a consumer's/user's agents and is designed to encourage some form of consumer action.

Herein, the term “electronic media based advertisement and/or marketing device” is used to denote any advertisement and/or marketing device distributed primarily, and/or initially, as electronic data by any method and/or mechanism for distributing electronic media based advertisements and/or marketing devices as discussed herein, and/or as known in the art at the time of filing, and/or as developed/made available after the time of filing.

In various embodiments, the offers and/or information regarding the products or services offered by the participating businesses are generated at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 by the participating businesses and then distributed by the provider of process for providing targeted advertisements based on positional tracking of mobile devices and financial data 300.

In various embodiments, the offers and/or information regarding the products or services offered by the participating businesses are generated and/or distributed at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 by the participating businesses.

In various embodiments, the offers and/or information regarding the products or services offered by the participating businesses are generated and/or distributed at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 by the provider of process for providing targeted advertisements based on positional tracking of mobile devices and financial data 300.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided/distributed to the consumers through any data link as discussed herein, and/or as known in the art at the time of filing, and/or as developed after the time of filing.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided/distributed to the consumers through one or more databases, such as databases 170 and/or 172 of FIG. 1, and/or as discussed herein, and/or as known in the art at the time of filing, and/or as developed after the time of filing.

Returning to FIG. 3 in one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided/distributed to the consumers through one or more mobile communication networks, such as mobile communication network of FIG. 1, and/or as discussed herein, and/or as known in the art at the time of filing, and/or as developed after the time of filing.

Returning to FIG. 3 in one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided/distributed to the consumers through one or more networks, such as network 130 of FIG. 1, and/or as discussed herein, and/or as known in the art at the time of filing, and/or as developed after the time of filing.

Returning to FIG. 3 in one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the offers and/or information are provided/distributed to the consumers using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 a probability that a given offer and/or information regarding a given participating business will effect a given consumer, i.e., cause the given consumer to become a customer, is calculated and provided to the participating business.

As noted above, in one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 311 the data regarding the position of the one or more mobile devices of OBTAIN POSITIONAL DATA FOR THE ONE OR MORE MOBILE DEVICES ASSOCIATED WITH THE ONE OR MORE CONSUMERS AT TWO OR MORE DIFFERENT TIMES OPERATION 309, and, in some embodiments, various data specific to a given consumer, is used to calculate, and/or update, an estimated direction/path and speed for the one or more consumers.

In one embodiment, PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the estimated direction/path and speed for the one or more consumers is used to calculate, and/or update, a point on the consumer's estimated path that is closest to the particular participating business.

In one embodiment, PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the estimated direction/path and speed for the one or more consumers is also used to calculate, and/or update, estimated arrival times at the point closest to the particular participating business.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the data regarding the estimated arrival times of one or more of the one or more consumers at a point closest to the particular participating business is used to calculate an estimated best, or “ideal” time to send the one or more offers and/or information regarding the participating business to a given consumer.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the probabilities that a given offer and/or information regarding a given participating business delivered at specific times will effect a given consumer, i.e., cause the given consumer to become a customer, is calculated and provided to the participating business for one or more specific times.

As a specific illustrative example, if it were determined that a given consumer was going to arrive at a point closest to a given Starbuck's coffee shop at 11:10 AM, then the Starbucks coffee shop might be given data by process for providing targeted advertisements based on positional tracking of mobile devices and financial data 300 indicating that a given offer delivered at 8:30 AM would have a 25% probability of drawing the given consumer in, while the same offer delivered at 10:50 AM would have a 55% probability of drawing the given consumer in because the consumer would be closer to real time use of offer. In addition, in this specific example, the Starbucks coffee shop might be given information by process for providing targeted advertisements based on positional tracking of mobile devices and financial data 300 indicating that the given offer delivered at 11:15 AM would have a 5% probability of drawing the given consumer in because the consumer would have to turnaround and/or change path in order to redeem the offer.

As noted above, in one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the probability of use parameters and/or data associated with a particular consumer is used to create offers and/or information customized, or tailored, to the given consumer to maximize the probability that the particular consumer will respond to the offer or advertisement for a particular participating business.

In one embodiment, at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 the one or more offers and/or information regarding the participating business are monitored and results are correlated to obtain usage/redemption feedback data that is then used to refine future recommendations and track the effectiveness of the various offers and/or information disseminated and/or for specific consumers, times and dates.

In one embodiment, once the participating businesses of CALCULATE A PROBABILITY THAT A GIVEN CONSUMER OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 313 are provided the opportunity to send one or more of the consumers of CALCULATE A PROBABILITY THAT THE GIVEN CONSUMER WILL UTILIZE THE GIVEN PARTICIPATING BUSINESS IN RESPONSE TO AN OFFER AND/OR INFORMATION REGARDING THE GIVEN PARTICIPATING BUSINESS OPERATION 315 one or more offers and/or information regarding the participating businesses at time based, at least in part, on the consumers estimated path and speed, and that can include, but are not limited to, an advertisement, a coupon, and/or any other marketing device, and/or electronic media based advertisement and/or marketing device at PROVIDE GIVEN CONSUMER WITH ONE OR MORE OFFERS AND/OR INFORMATION REGARDING THE GIVEN PARTICIPATING BUSINESS AT A TIME DETERMINED BASED, AT LEAST IN PART, ON THE ESTIMATED DIRECTION AND SPEED OF THE GIVEN CONSUMER OPERATION 317 process flow proceeds to EXIT OPERATION 330. In one embodiment, at EXIT OPERATION 330 process for providing targeted advertisements based on positional tracking of mobile devices and financial data 300 is exited to await new data.

In the discussion above, certain aspects of one embodiment include process steps or operations or instructions described herein for illustrative purposes in a particular order or grouping. However, the particular order or grouping shown and discussed herein is illustrative only and not limiting. Those of skill in the art will recognize that other orders or grouping of the process steps or operations or instructions are possible and, in some embodiments, one or more of the process steps or operations or instructions discussed above can be combined or deleted. In addition, portions of one or more of the process steps or operations or instructions can be re-grouped as portions of one or more other of the process steps or operations or instructions discussed herein. Consequently, the particular order or grouping of the process steps or operations or instructions discussed herein does not limit the scope of the invention as claimed below.

Using one embodiment of process for providing targeted advertisements based on positional tracking of mobile devices and financial data 300, actual financial data associated with consumers and actual potential customer positions, and/or predicted potential customer paths and movement, is/are used to provide a business owner the information to more accurately identify potential customers and to identify potential customers who are currently in the vicinity of the business, and/or are predicted to be in the vicinity of the business at a given time. Then using process for providing targeted advertisements based on positional tracking of mobile devices and financial data 300, the business owner/operator is provided the opportunity to specifically target those potential customers with advertisements and/or offers and to provide the potential customers advertisements and/or offers at the most advantageous time, e.g., when the potential customers are nearby, yet have time to divert from their current path to make a stop at the given business. Consequently, using process for providing targeted advertisements based on positional tracking of mobile devices and financial data 300, businesses are provided the information and mechanism necessary to most effectively and efficiently target consumers and consumers are provided the ability to receive offers/advertisements that are most relevant, and potentially useful, to the consumer. Therefore, both businesses and consumers are directly benefited by use of process for providing targeted advertisements based on positional tracking of mobile devices and financial data 300.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “registering”, “linking”, “distributing”, “calculating”, “estimating”, “using”, “determining”, “generating”, “obtaining”, “identifying”, “analyzing”, “presenting”, “storing”, “saving”, “displaying”, “categorizing”, “providing”, “processing”, “accessing”, “monitoring” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS. and discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A method for providing targeted advertisements based on positional tracking of mobile devices comprising:
obtaining location data for one or more participating businesses;
obtaining positional data for mobile devices associated with one or more consumers;
using the positional data for the mobile devices associated with each one of the one or more consumers to estimate a direction or path and speed of the mobile devices, and therefore an estimated direction or path and speed of the associated consumers;
for each one of the one or more mobile devices:
analyzing data representing the estimated direction or path and speed of the mobile device and the associated consumer, and the location data for the one or more participating businesses to determine which of the one or more participating businesses is located within a defined distance of the estimated direction or path of the mobile device and the associated consumer;
using the data representing the estimated direction or path and speed of the mobile device and associated consumer to estimate an arrival time of the associated consumer at location within a defined distance of a participating business located within a defined distance of the estimated direction or path of the mobile device and the associated consumer; and
providing at least one of the associated consumers with an offer, advertisement, or information associated with a participating business located within a defined distance of the estimated direction or path of the mobile device and the associated consumer through the mobile device associated with the consumer and at a time determined, at least in part, by the estimated arrival time of the associated consumer at location within a defined distance of the participating business.

2. The method for providing targeted advertisements based on positional tracking of mobile devices of claim 1, wherein;
the location data for one or more participating businesses is obtained as part of a registration or subscription to a service for providing targeted advertisements based on positional tracking of mobile devices and financial data.

3. The method for providing targeted advertisements based on positional tracking of mobile devices of claim 1, wherein;
the positional data for one or more mobile devices is obtained at least twice.

4. The method for providing targeted advertisements based on positional tracking of mobile devices of claim 1, wherein;
the positional data for one or more mobile devices is obtained at regular intervals.

5. The method for providing targeted advertisements based on positional tracking of mobile devices of claim 4, wherein;
the positional data for one or more mobile devices obtained at regular intervals is used to update the estimated direction or path and speed of the one or more mobile devices, and therefore an estimated direction or path and speed of the associated consumers, at regular intervals.

6. The method for providing targeted advertisements based on positional tracking of mobile devices of claim 1, wherein;
calendar data and scheduled meeting locations associated with an associated consumer are used to modify the estimated direction or path and speed of the associated consumer.

7. A method for providing targeted advertisements based on positional tracking of mobile devices and financial data comprising:
obtaining location data for one or more participating businesses;
obtaining financial data associated with one or more consumers;
linking the financial data for each one of the one or more consumers with mobile devices associated with each one of the one or more consumers;
obtaining positional data for the mobile devices associated with each one of the one or more consumers;
using the positional data for the mobile devices associated with each one of the one or more consumers to estimate a direction or path and speed of the mobile devices, and therefore an estimated direction or path and speed of the associated consumers;
for each one of the one or more mobile devices:
analyzing data representing the estimated direction or path and speed of the mobile device and the associated consumer, and the location data for the one or more participating businesses to determine which of the one or more participating businesses is located within a defined distance of the estimated direction or path of the mobile device and the associated consumer;
using the financial data associated with the associated consumer to determine a probability that the associated consumer will utilize a participating business located within a defined distance of the estimated direction or path of the mobile device and the associated consumer in response to receiving an offer, advertisement, or information associated with the participating business;
using the data representing the estimated direction or path and speed of the mobile device and associated consumer to estimate an arrival time of the associated consumer at location within a defined distance of the participating business; and
based, at least in part, on the probability that an associated consumer will utilize a participating business located within a defined distance of the estimated direction or path of the mobile device and the associated consumer in response to receiving an offer, advertisement, or information associated with the participating business, providing the associated consumer with an offer, advertisement, or information associated with the participating business at a time determined, at least in part, on the estimated arrival time of the associated consumer at location within a defined distance of the participating business.

8. The method for providing targeted advertisements based on positional tracking of mobile devices and financial data of claim 7, wherein;
the location data for one or more participating businesses is obtained as part of a registration or subscription to a service for providing targeted advertisements based on positional tracking of mobile devices and financial data.

9. The method for providing targeted advertisements based on positional tracking of mobile devices and financial data of claim 7, wherein;
the positional data for one or more mobile devices is obtained at least twice.

10. The method for providing targeted advertisements based on positional tracking of mobile devices and financial data of claim 7, wherein;
the positional data for one or more mobile devices is obtained at regular intervals.

11. The method for providing targeted advertisements based on positional tracking of mobile devices and financial data of claim 10, wherein;
the positional data for one or more mobile devices obtained at regular intervals is used to update the estimated direction or path and speed of the one or more mobile devices, and therefore an estimated direction or path and speed of the associated consumers, at regular intervals.

12. The method for providing targeted advertisements based on positional tracking of mobile devices and financial data of claim 7, wherein;
calendar data and scheduled meeting locations associated with an associated consumer are used to modify the estimated direction or path and speed of the associated consumer.

13. A method for providing targeted advertisements based on positional tracking of mobile devices comprising:
obtaining location data for one or more participating businesses;
obtaining positional data for mobile devices associated with one or more consumers;
using the positional data for the mobile devices associated with each one of the one or more consumers to estimate a direction or path and speed of the mobile devices, and therefore an estimated direction or path and speed of the associated consumers;
for each one of the one or more mobile devices:
analyzing data representing the estimated direction or path and speed of the mobile device and the associated consumer, and the location data for the one or more participating businesses to determine which of the one or more participating businesses is located within a defined distance of the estimated direction or path of the mobile device and the associated consumer;
using one or more probability of use parameters associated with the associated consumer to determine a probability that the associated consumer will utilize a participating business located within a defined distance of the estimated direction or path of the mobile device and the associated consumer in response to receiving an offer, advertisement, or information associated with the participating business;
using the data representing the estimated direction or path and speed of the mobile device and associated consumer to estimate an arrival time of the associated consumer at location within a defined distance of the participating business; and
based, at least in part, on the probability that an associated consumer will utilize a participating business located within a defined distance of the estimated direction or path of the mobile device and the associated consumer in response to receiving an offer, advertisement, or information associated with the participating business, providing the associated consumer with an offer, advertisement, or information associated with the participating business at a time determined, at least in part, on the estimated an arrival time of the associated consumer at location within a defined distance of the participating business.

14. The method for providing targeted advertisements based on positional tracking of mobile devices of claim 13, wherein;
the positional data for one or more mobile devices is obtained at least twice.

15. The method for providing targeted advertisements based on positional tracking of mobile devices of claim 13, wherein;
the positional data for one or more mobile devices is obtained at regular intervals.

16. The method for providing targeted advertisements based on positional tracking of mobile devices of claim 15, wherein;
the positional data for one or more mobile devices obtained at regular intervals is used to update the estimated direction or path and speed of the one or more mobile devices, and therefore an estimated direction or path and speed of the associated consumers, at regular intervals.

17. The method for providing targeted advertisements based on positional tracking of mobile devices of claim 13, wherein;
calendar data and scheduled meeting locations associated with an associated consumer are used to modify the estimated direction or path and speed of the associated consumer.

18. The method for providing targeted advertisements based on positional tracking of mobile devices of claim 13, wherein;
how close the estimated direction or path and speed of the associated consumer brings the associated consumer to a participating business is used as at least one probability of use parameter to calculate the probability that the associated consumer will utilize a participating business in response to receiving an offer,
advertisement, or information associated with the participating business.

19. The method for providing targeted advertisements based on positional tracking of mobile devices of claim 13, wherein;
calendar data and the location of scheduled meetings associated with an associated consumer is used as at least one probability of use parameter to calculate the probability that the associated consumer will utilize a participating business in response to receiving an offer, advertisement, or information associated with the participating business.

20. The method for providing targeted advertisements based on positional tracking of mobile devices of claim 13, wherein;
calendar data and the time scheduled meetings associated with an associated consumer is used as at least one probability of use parameter to calculate the probability that the associated consumer will utilize a participating business in response to receiving an offer, advertisement, or information associated with the participating business.

21. A system for providing targeted advertisements based on positional tracking of mobile devices comprising:
one or more participating businesses;
one or more mobile devices associated with one or more consumers, each of the one or more mobile devices being associated with a consumer of the one or more consumers; and
one or more processors associated with one or more computing systems, the one or more computing systems implementing at least part of a process for providing targeted advertisements based on positional tracking of mobile devices, the process for providing targeted advertisements based on positional tracking of mobile devices including:
obtaining location data for the one or more participating businesses using the one or more processors associated with one or more computing systems;
obtaining positional data for the mobile devices associated with one or more consumers using the one or more processors associated with one or more computing systems;
using the one or more processors associated with one or more computing systems and the positional data for the mobile devices associated with each one of the one or more consumers to estimate a direction or path and speed of the mobile devices, and therefore an estimated direction or path and speed of the associated consumers;
for each one of the one or more mobile devices:
using the one or more processors associated with one or more computing systems to analyze data representing the estimated direction or path and speed of the mobile device and the associated consumer, and the location data for the one or more participating businesses to determine which of the one or more participating businesses is located within a defined distance of the estimated direction or path of the mobile device and the associated consumer;
using the one or more processors associated with one or more computing systems and the data representing the estimated direction or path and speed of the mobile device and associated consumer to estimate an arrival time of the associated consumer at location within a defined distance of a participating business located within a defined distance of the estimated direction or path of the mobile device and the associated consumer; and
using the one or more processors associated with one or more computing systems to provide at least one of the associated consumers with an offer, advertisement, or information associated with a participating business located within a defined distance of the estimated direction or path of the mobile device and the associated consumer through the mobile device associated with the consumer and at a time determined, at least in part, by the estimated arrival time of the associated consumer at location within a defined distance of the participating business.

22. The system for providing targeted advertisements based on positional tracking of mobile devices of claim 21, wherein;
the location data for one or more participating businesses is obtained as part of a registration or subscription to a service for providing targeted advertisements based on positional tracking of mobile devices and financial data.

23. The system for providing targeted advertisements based on positional tracking of mobile devices of claim 21, wherein;
the positional data for one or more mobile devices is obtained at least twice.

24. The system for providing targeted advertisements based on positional tracking of mobile devices of claim 21, wherein;
the positional data for one or more mobile devices is obtained at regular intervals.

25. The system for providing targeted advertisements based on positional tracking of mobile devices of claim 24, wherein;
the positional data for one or more mobile devices obtained at regular intervals is used to update the estimated direction or path and speed of the one or more mobile devices, and therefore an estimated direction or path and speed of the associated consumers, at regular intervals.

26. The system for providing targeted advertisements based on positional tracking of mobile devices of claim 21, wherein;
calendar data and scheduled meeting locations associated with an associated consumer are used to modify the estimated direction or path and speed of the associated consumer.

27. A system for providing targeted advertisements based on positional tracking of mobile devices and financial data comprising:
one or more participating businesses;
one or more mobile devices associated with one or more consumers, each of the one or more mobile devices being associated with a consumer of the one or more consumers; and
one or more processors associated with one or more computing systems, the one or more computing systems implementing at least part of a process for providing targeted advertisements based on positional tracking of mobile devices and financial data, the process for providing targeted advertisements based on positional tracking of mobile devices and financial data including:
obtaining location data for the one or more participating businesses using the one or more processors associated with one or more computing systems;
obtaining financial data associated with the one or more consumers using the one or more processors associated with one or more computing systems;
linking the financial data for each one of the one or more consumers with the mobile devices associated with each one of the one or more consumers using the one or more processors associated with one or more computing systems;
obtaining positional data for the mobile devices associated with each one of the one or more consumers using the one or more processors associated with one or more computing systems;
using the one or more processors associated with one or more computing systems and the positional data for the mobile devices associated with each one of the one or more consumers to estimate a direction or path and speed of the mobile devices, and therefore an estimated direction or path and speed of the associated consumers;
for each one of the one or more mobile devices:
using the one or more processors associated with one or more computing systems to analyze data representing the estimated direction or path and speed of the mobile device and the associated consumer, and the location data for the one or more participating businesses to determine which of the one or more participating businesses is located within a defined distance of the estimated direction or path of the mobile device and the associated consumer;
using the one or more processors associated with one or more computing systems and the financial data associated with the associated consumer to determine a probability that the associated consumer will utilize a participating business located within a defined distance of the estimated direction or path of the mobile device and the associated consumer in response to receiving an offer, advertisement, or information associated with the participating business;
using the one or more processors associated with one or more computing systems and the data representing the estimated direction or path and speed of the mobile device and associated consumer to estimate an arrival time of the associated consumer at location within a defined distance of the participating business; and
based, at least in part, on the probability that an associated consumer will utilize a participating business located within a defined distance of the estimated direction or path of the mobile device and the associated consumer in response to receiving an offer, advertisement, or information associated with the participating business, using the one or more processors associated with one or more computing systems to provide the associated consumer with an offer, advertisement, or information associated with the participating business at a time determined, at least in part, on the estimated arrival time of the associated consumer at location within a defined distance of the participating business.

28. The system for providing targeted advertisements based on positional tracking of mobile devices and financial data of claim 27, wherein;
the location data for one or more participating businesses is obtained as part of a registration or subscription to a service for providing targeted advertisements based on positional tracking of mobile devices and financial data.

29. The system for providing targeted advertisements based on positional tracking of mobile devices and financial data of claim 27, wherein;
the positional data for one or more mobile devices is obtained at least twice.

30. The system for providing targeted advertisements based on positional tracking of mobile devices and financial data of claim 27, wherein;
the positional data for one or more mobile devices is obtained at regular intervals.

31. The system for providing targeted advertisements based on positional tracking of mobile devices and financial data of claim 30, wherein;
the positional data for one or more mobile devices obtained at regular intervals is used to update the estimated direction or path and speed of the one or more mobile devices, and therefore an estimated direction or path and speed of the associated consumers, at regular intervals.

32. The system for providing targeted advertisements based on positional tracking of mobile devices and financial data of claim 27, wherein;
calendar data and scheduled meeting locations associated with an associated consumer are used to modify the estimated direction or path and speed of the associated consumer.

33. A system for providing targeted advertisements based on positional tracking of mobile devices comprising:
one or more participating businesses;
one or more mobile devices associated with one or more consumers, each of the one or more mobile devices being associated with a consumer of the one or more consumers; and
one or more processors associated with one or more computing systems, the one or more computing systems implementing at least part of a process for providing targeted advertisements based on positional tracking of mobile devices, the process for providing targeted advertisements based on positional tracking of mobile devices including:
obtaining location data for the one or more participating businesses using the one or more processors associated with one or more computing systems;
obtaining positional data for the mobile devices associated with one or more consumers using the one or more processors associated with one or more computing systems;
using the one or more processors associated with one or more computing systems and the positional data for the mobile devices associated with each one of the one or more consumers to estimate a direction or path and speed of the mobile devices, and therefore an estimated direction or path and speed of the associated consumers;
for each one of the one or more mobile devices:
using the one or more processors associated with one or more computing systems to analyze data representing the estimated direction or path and speed of the mobile device and the associated consumer, and the location data for the one or more participating businesses to determine which of the one or more participating businesses is located within a defined distance of the estimated direction or path of the mobile device and the associated consumer;
using the one or more processors associated with one or more computing systems and one or more probability of use parameters associated with the associated consumer to determine a probability that the associated consumer will utilize a participating business located within a defined distance of the estimated direction or path of the mobile device and the associated consumer in response to receiving an offer, advertisement, or information associated with the participating business;
using the one or more processors associated with one or more computing systems and the data representing the estimated direction or path and speed of the mobile device and associated consumer to estimate an arrival time of the associated consumer at location within a defined distance of the participating business; and
based, at least in part, on the probability that an associated consumer will utilize a participating business located within a defined distance of the estimated direction or path of the mobile device and the associated consumer in response to receiving an offer, advertisement, or information associated with the participating business, using the one or more processors associated with one or more computing systems to provide the associated consumer with an offer, advertisement, or information associated with the participating business at a time determined, at least in part, on the estimated an arrival time of the associated consumer at location within a defined distance of the participating business.

34. The system for providing targeted advertisements based on positional tracking of mobile devices of claim 33, wherein;
the positional data for one or more mobile devices is obtained at least twice.

35. The system for providing targeted advertisements based on positional tracking of mobile devices of claim 33, wherein;
the positional data for one or more mobile devices is obtained at regular intervals.

36. The system for providing targeted advertisements based on positional tracking of mobile devices of claim 35, wherein;
the positional data for one or more mobile devices obtained at regular intervals is used to update the estimated direction or path and speed of the one or more mobile devices, and therefore an estimated direction or path and speed of the associated consumers, at regular intervals.

37. The system for providing targeted advertisements based on positional tracking of mobile devices of claim 33, wherein;
calendar data and scheduled meeting locations associated with an associated consumer are used to modify the estimated direction or path and speed of the associated consumer.

38. The system for providing targeted advertisements based on positional tracking of mobile devices of claim 33, wherein;
how close the estimated direction or path and speed of the associated consumer brings the associated consumer to a participating business is used as at least one probability of use parameter to calculate the probability that the associated consumer will utilize a participating business in response to receiving an offer,
advertisement, or information associated with the participating business.

39. The system for providing targeted advertisements based on positional tracking of mobile devices of claim 33, wherein;
calendar data and the location of scheduled meetings associated with an associated consumer is used as at least one probability of use parameter to calculate the probability that the associated consumer will utilize a participating business in response to receiving an offer, advertisement, or information associated with the participating business.

40. The system for providing targeted advertisements based on positional tracking of mobile devices of claim 33, wherein;
calendar data and the time scheduled meetings associated with an associated consumer is used as at least one probability of use parameter to calculate the probability that the associated consumer will utilize a participating business in response to receiving an offer, advertisement, or information associated with the participating business.
